(19) United States
(12) Patent Application Publication
(10) Pub. No.: US 2012/0046179 A1
(43) Pub. Date: Feb. 23, 2012

(54) METHOD OF POOLING SAMPLES FOR PERFORMING A BIOLOGICAL ASSAY

(75) Inventors: Adrianus Lambertus Johannus Vereijken, Boxmeer (NL); Annemieke Paula Jungerius, Rhenen (NL); Gerardus Antonius Arnoldus Albers, Boxmeer (NL)

(73) Assignee: Hendrix Genetics Research, Technology & Services B. V.

(21) Appl. No.: 13/318,111

(22) PCT Filed: Apr. 29, 2010
(86) PCT No.: PCT/NL2010/050252

§ 371 Date: Oct. 28, 2011

(30) Foreign Application Priority Data
Apr. 29, 2009 (NL) PCT/NL2009/050238

(51) Int. Cl. C40B 20/00; C40B 50/00; C40B 30/10; C40B 60/10; C40B 60/08; C40B 60/06; C40B 60/12; C40B 30/00; C40B 20/08

(52) U.S. Cl. 506/6; 506/7; 506/2; 506/23; 506/12; 506/37; 506/36; 506/39; 506/38

(57) ABSTRACT

The present invention relates among others to a method of pooling samples to be analyzed for a categorical variable, wherein the analysis involves a quantitative measurement of an analyte, said method of pooling samples comprising providing a pool of n samples wherein the amount of individual samples in the pool is such that the analytes in the samples are present in a molar ratio of x⁰:x¹:x²:x⁽ⁿ⁻¹⁾, and wherein x is equal to a positive value other than 1 representing the pooling factor.

### FIELD OF THE INVENTION

The invention relates to the field of measurements with categorical outcome on biological samples, more in particular to methods for sample preparation of bioassays with categorical outcome. The present invention provides a method of pooling samples, e.g. in methods for performing a biological assay; and the use of said method, for instance for genotyping an allelic variant. The invention further provides a method of performing an analysis on multiple samples, a pooling device for pooling multiple samples into a pooled sample, an analysis device comprising a processor that is arranged for performing an analysis on a set of pooled sample, a computer program product that can implement a method of pooling samples, and a computer program product that can implement a method for performing an analysis on multiple samples.

### BACKGROUND OF THE INVENTION

A bioassay is a procedure where a property, concentration or presence of a biological analyte is measured in a sample, or an analyte in a biological sample. Bioassays are an intrinsic part of research in all fields of science, most notably in life sciences and especially in molecular biology.

A particular type of analysis in molecular biology relates to genotyping and sequencing. Genotyping and sequencing refers to the process of determining the genotype of an individual with a biological assay. Current methods include PCR, DNA and RNA sequencing, and hybridization to DNA and RNA microarrays mounted on various carriers such as glass plates or beads. The technology is intrinsic for test on father/motherhood, in clinical research for the investigation of disease-associated genes and in other research aimed at investigating the genetic control of properties of any species for instance whole genome scans for QTL's (Quantitative Trait Loci).

Due to current technological limitations, almost all genotyping is partial. That is, only a small fraction of an individual's genotype is determined. In many instances this is not a problem. For instance, when testing for father-/motherhood, only 10 to 20 genomic regions are investigated to determine relationship or lack thereof, which is a tiny fraction of the human genome.

Single nucleotide polymorphisms (SNPs) are the most abundant type of polymorphism in the genome. With the parallel developments of dense SNP marker maps and technologies for high-throughput SNP genotyping, SNPs have become the markers of choice for many genetic studies. A substantial number of samples is required in mapping and association studies or in genomic selection experiments.

In order to provide for high-throughput genotyping capabilities, arraying technologies have been developed. Such technologies are available from commercial suppliers such as Affymetrix (microarray-based GeneChip® Mapping arrays), Illumina (BeadArray™), Biotrove (Open Array™) and Sequenom (MassARRAY™). In many species (humans, livestock, plants, bacteria and viruses) a large number of SNPs is available or will become available in the near future. New innovations have enabled whole-genome genotyping or association studies and associated whole-genome selection programs for plant and animal breeding. Yet the costs of such programs are still significant, requiring budgets of up to several millions of dollars if samples are individually genotyped. Therefore, studies aimed at identifying SNPs in any species, currently involve analysis of only a limited number of individuals. The current invention therefore is of great significance since it allows a very substantial reduction of the cost of genotyping.

In order to obtain full insight in genomic variability it is necessary to know the full sequence of (a relevant part of) the genome. However, the cost of determining the full sequence is even higher than the cost of genotyping which is described in the previous paragraph. Despite the costs, it is expected that sequencing will replace genotyping to provide individual genotypes for the entire genome or specific regions thereof. The current invention also provides methods to reduce the cost of sequencing.

Sample pooling is regularly used in studies on categorical traits as a means to reduce analysis costs. The presence of the characteristic in the pool, consisting of a mixture of several samples indicates the presence of that characteristic in at least one of the samples in that pool. DNA pools are for instance used for:
estimating allele frequencies in a population.
By taking a good sample of individuals from the population, the raw allele frequency of allele 1 is calculated as the ratio between the result for allele 1 and the sum of the result for allele1 and the result for allele2 in the pool.
case—control association studies wherein cases and controls are divided into separate pools, and
reconstructing haplotypes on a limited number of individuals and a limited number of SNPs.
Based on the allele frequencies measured in the pool, haplotypes can be estimated by different algorithms such as maximum likelihood. The term haplotype frequency is synonymous with the term joint distribution of markers.

An important disadvantage of sample pooling is that the measured characteristic is only identified in the pool as a whole, and not in any of the individual samples in the pool. One exception is DNA pools for genotyping trios (father, mother and child) when two pools each consisting of two individuals are created (father+child and mother+child). The observed allele frequency in each pool is indicative of the genotypes for all 3 individuals. This type of sample pooling provides a cost reduction of 33% but is only possible with such trios. In all other instances, pooled samples must be re-analysed individually in order to provide results for the individual samples.

Thus, it would be beneficial to provide sample pools for sample types other than trios, while still providing test results for the individual samples within that pool.

The present inventors have now discovered that random individuals can be pooled and that individual genotypes can be recovered from such pools when the contribution of each individual sample in the pool is a fixed proportion of that of each other sample, i.e. when sample amounts are not equimolar but provided in specific ratios. Results for individual samples can be inferred from the pooled test-result provided that the test involves a quantitative measure of a categorical variable, i.e. that the test involves a categorical or discrete trait that is quantitatively measured.

In fact, the present inventors have found that for the study of the presence of a certain allele at a certain locus in a diploid animal, the mixing in a ratio of for instance 1:3 of a DNA sample of a first diploid animal having 2 possible alleles (A or B) at a single locus, with a DNA sample of a second diploid animal also having 2 possible alleles (A or B) at the same locus, results in the presence of (2)+(2+2+2)=8 possibilities for either of the alleles in that mixture, wherein the expected quantitative instrument signal from a single allele (e.g. A) is 12.5% of the maximum sample signal strength. This means that at a measured signal intensity of 37.5% of maximum sample signal strength, the sample comprises 3 x the allele A, which means that the signal cannot originate from the first diploid animal and can only originate from the second diploid animal, indicating that the first diploid animal has genotype BB and the second diploid animal has genotype AB. Likewise, when the measured signal intensity is 50% of maximum sample signal strength, all samples have genotype AB. When the measured signal intensity is 0% of maximum sample signal strength, then all samples have genotype BB. The 2 individuals in the pool have in total 3*3 potential combinations of individual genotypes. Provided the actual measurement deviates not more than 6.25% of its expected outcome, each measurement can be allocated to a single value which is zero, one, two, three, four, five, six, seven or eight-eighth of 100% of maximum sample signal strength. In general, each possible measurement result can be allocated to a value which is zero or 1 to (p+1)ⁿ multiples of 1/((p+1)n−1)*100% wherein p is the ploidy level, n is the number of samples and 100% is the maximum sample signal strength. In total there will be (ploidy level+1)ⁿ potential combinations of individual genotypes.

Now when pooling samples of 3 animals (x, y and z) in a ratio of 1:3:9 (respectively, that is, with a pooling factor of 3), there are in theory a total of 26 possibilities for either of the alleles in that mixture, wherein the expected quantitative signal from a single occurrence of an allele (e.g. A) is 3.85% of the maximum sample signal strength. This means that at a measured signal intensity of 12% of maximum sample signal strength, the sample comprises 3 x the allele A indicating that animal x has genotype BB, animal y has genotype AB, and animal z has genotype BB. Likewise, when the measured signal intensity is 96% of maximum sample signal strength, sample x has genotype AB, while samples y and z have genotype AA. Provided the accuracy of the measurement is at least 1.9%, each measurement can be allocated to a value zero, or one to up to 26 multiples of one-twentysixth ( 1/26) of 100% of maximum sample signal strength. (For an overview of possible outcomes for such a pooled experiment see the Examples below).

The highest accuracy in measurement for each individual sample in the pool is attained when the intervals between each of the measurement points are equal. This is for instance achieved when using a pooling factor of 3 in diploid individuals. In fact, optimal results are attained when the pooling factor equals the potential number of genotypes present in the pool. The maximum number of genotypes for analyses involving two alleles in diploid organisms is 3 (AA, AB and BB), indicating that a pooling factor of 3 is optimal for such analyses. In haploid organisms this number is 2.

As mentioned above, the highest accuracy in measurement for each individual sample in the pool is attained when the intervals between each of the measurement points (“result points”) are equal. This is attained when the samples are pooled with a constant pooling factor and where this constant pooling factor equals the potential number of genotypes present in the pool or the ploidy level +1. Examples are pooling ratio's of 1:3 or 1:3:9 or 1:3:9:27 for samples of diploid organisms that are to be tested for a genotype that can vary from AA, AB to BB and where the number of samples in the pool are respectively 2, 3 and 4.

However, often it is not necessary to have the highest accuracy and it suffices to have the intervals sufficiently apart to allow for the discrimination between two consecutive result points. This is in the above example also achieved with ratio's of for instance 1:2,5:9 and 1:2,5:8. The artisan can find suitable other ratio's on the basis of the number of samples in the pool, the number of values for the categorical variable and the accuracy of the detection procedure. Intervals between individual result points as low as 1% are possible with the appropriate setup and it is expected that even lower intervals between individual results will become possible as the technology develops.

One way to quickly arrive at suitable pooling ratio's is the use of a constant pooling factor. The pooling factor does not have to be equal to the number of expected outcomes in the pool. A deviation from the optimal value may, however, cause an inaccuracy in the measurement. For example, when analysing 3 individuals for two alleles using a pooling factor of 3, the expected quantitative signal from a single occurrence of an allele (e.g. A) is 3.85% of the maximum sample signal strength as described above and the interval between result points is thus 3.85% in the ideal situation wherein the pooling factor is 3. A small deviation from the pooling factor will result in certain intervals between result points having values higher than 3.85%, while at the same time, other intervals between result points having values lower than 3.85%. In principle, the pooling factor may be chosen such that the interval between individual result points is as low as 1% or even lower. As long as the assay allows for the discrimination between two consecutive result points, the pooling factor is suitable. Hence, the pooling factor in aspects of the present invention may have any positive value other than 1. The pooling factor is thus a parameter that can be changed for different experiments in a single assay, whereas the number of classes for the categorical trait in a given assay is a constant value.

If 2 diploid individuals are pooled in a ratio 1:4 (also different from the optimal ratio 1:3) the incremental steps will not be equal anymore. In this case there will be 0+0, 1+0, 2+0 , 0+4, 1+4, 2+4 ,0+8, 1+8 or 2+8 number of occurrences of A allele from first individual +number of occurrences of A allele from second individual times 4).

Total number of occurrences of allele A in the pool will be 2+2*4=10.

Expected measurement results will then be 0%, 10%, 20%, 40%, 50%, 60%, 80%, 90% and 100%.

So incremental steps are not equal to 12.5% but are either 10% or 20%. Discrimination between 0, 1 or 2 occurrences of A allele for individual 1 is more difficult while discrimination between 0, 1 or 2 occurrences of A allele for individual 2 becomes easier.

With a pooling factor of 3.5 there will be 0+0, 1+0, 2+0, 0+3.5, 1+3.5, 2+3.5, 0+7, 1+7 or 2+7 occurrences of A allele in the pool with a total of 2+2*3.5=9 occurrences.

Expected measurement results will then be 0%, 1/9*100=11.1% , 22.2%, 3.5/9*100=38.9%, 50%, 61.1%, 7/9*100=77.8%, 88,9% and 100%. Incremental steps are now 11.1% or 16.7%.

In one embodiment the invention provides a method for typing nucleic acid at a first position in the nucleic acid of at least two sources in an assay,

said method comprising

providing from each of said at least two sources an individual sample comprising nucleic acid of said source

and

pooling said individual samples such that the ratio of amounts of nucleic acid of said at least two sources in the pool allows for the assay to discriminate between the frequencies of each potential variant at said position in said assay,

said method further comprising

measuring the frequency of occurrence of at least one of said potential variants in said pooled sample

and;

determining from said measured frequency, the nucleic acid type at said first position in the nucleic acid of said at least two sources. This embodiment is particularly suited to determine the variants that are present at said first position in the nucleic acid of said at least two sources. The first position in the nucleic acid in one of said at least two sources is preferably the same as the first position in another of said at least two sources. For instance, in the case this embodiment is used to sequence nucleic acid it is preferred that said first position is the same in said at least two sources. In that case one can suffice with a single primer to initiate the sequencing of nucleic acid from both sources. However, the first positions can also be different from each other. In the sequencing example this embodiment is exemplified by use of a primer specific for the first position in the nucleic acid of the first source and a second different primer that is specific for the first position in the nucleic acid from the second source, which first position is in that case different for the first position in the nucleic acid of the first source.

The same position is herein defined as the same position relative to a common reference in the nucleic acid of said at least two sources. In sequencing the same position is typically defined as the same distance relative to the hybridization site of the primer on the nucleic acid of the at least two sources. Alternatively, when the position encompasses more nucleotides it can also refer to the same genetic element, such as a promoter, gene or locus. Such elements may exist in several more or less closely related forms between organisms. For instance in poultry the genes of the respective species have significant sequence identity but are nevertheless different. The invention can be used to identify or type such differences for said organisms. Thus in one aspect the nucleic acid of said at least two sources is nucleic acid of said least two organisms. In a preferred embodiment the at least two organisms are of the same species. Also in this case different individuals from the same species may vary from each other by the presence of different alleles or variants at said position. Such differences may be typed by a method of the invention.

Alternatively, in case the two organisms contain the same nucleotide or other variant at said first position the result of the method is that the first positions of the nucleic acid of the at least two organisms (or sources) is typed as the same. Apart from the typing as the same or different it is, for instance, also possible to type nucleic acid for a characteristic, for instance the presence or absence of a particular SNP or the presence or absence of a heritable trait such as blue eyes, brown eyes, susceptibility toward a certain disease, resistance to a herbicide etc.

A method of the invention can be used in the context of a variety of nucleic acid determination assays. Preferred assays are sequencing assays and hybridisation assays. The nucleic acid of said at least two sources can be DNA, RNA or a derivative thereof. RNA can be used in the present invention. In this embodiment it is preferred that pooling of said individual samples is such that the ratio of amounts of the specific RNAs to be typed in the RNA of said at least two sources in the pool, allows for the assay to discriminate between the frequencies of each potential variant at said position in said assay. In a preferred embodiment of the invention said nucleic acid is DNA. Also in the case of DNA it is preferred that pooling of said individual samples is such that the ratio of amounts of the specific DNAs to be typed in the DNA of said at least two sources in the pool, allows for the assay to discriminate between the frequencies of each potential variant at said position in said assay. For chromosomal DNA this can be done for instance by determining the DNA content of the sample as all unique chromosomal sequences on the chromosome are present in equimolar amounts. In a preferred embodiment said DNA is cellular DNA. Cells also contain non-nuclear DNA, for instance in mitochondria or chloroplasts. However, the amount of non-nuclear DNA does typically not interfere with such measurements as they constitute only a minor fraction of the total DNA in a cell. Needless to say, a method of the invention can also be used to type non-nuclear cellular DNA. Thus in a preferred embodiment said at least two organisms are cellular organisms. Preferably said nucleic acid at said first position is typed in the nucleic acid of cells of said at least two organisms.

In a preferred embodiment at least one of said individual samples contains nucleic acid of only one individual organism. Preferably essentially all individual samples contain nucleic acid of only one individual organism, and preferably essentially all of said individual organisms are from different organism specimens.

A method of the invention is in principle applied to pooling samples of individual organisms or sources. However, it is also possible to apply the invention by pooling a sample from an individual organism or source with at least one sample that comprises a pool of individual samples each comprising nucleic acid from an individual source or organism. It is also possible to pool at least two of such pools. Pooling in this case is preferably such that the ratio of amounts of nucleic acid from each of said individual sources or organisms in the final pool allows for the assay to discriminate between the frequencies of each potential variant at said position in said assay.

The frequency of occurrence of a variant at a position can be measured in various ways. Often a signal that is representative for the amount of a variant is determined. The signal can be any signal as long as it can be quantitated, for instance a light signal or radioactivity. This amount is then related to a reference to arrive at a frequency. In this embodiment it is preferred that said assay comprises a reference in which the frequency of occurrence of at least one of said variants at said first position is known. The measured frequency of occurrence is often expressed as a percentage in relation to the reference or other relative number. In a preferred embodiment the measured frequency is expressed as a percentage of the variant relative to the percentage of another variant for said position, which in that case is an internal reference. However, the measured frequency of occurrence can also be the indication high or low. The latter is sufficient for simple pooled samples and/or simple ratios, for instance, for a pool of two individual samples of haploid organisms with a ratio of 1:4.

Sequencing is one of the preferred assays of the invention. Sequencing can be used to type a nucleotide present at a certain position in the nucleic acid. Typing of the nucleotides at subsequent consecutive positions then results the sequence of the nucleic acid at the tested positions. When sequencing pools of individual samples that contain an individual sample of which the nucleic acid is derived from a polyploid (2 or more) cell it is also possible determine the nucleic acid type at the first position. When typing the pool for further positions it is not always necessary to determine the exact sequence thereof, for instance, for determining the allele frequency for each position. In addition it is often possible to determine the exact sequence in such cases by correlating the results with individual known genotypes or using pedigree information.

In a preferred embodiment the invention is used to genotype a polymorphic locus in an organism. It is presently possible to utilize the genotype differences between organisms of the same species in various ways. Genotyping is for instance of importance in the identification of markers that are associated with favourable or unfavourable traits. Subsequently the technique is also used in breeding for instance to select for increase or decrease of the trait level in the breeding population c.q. to increase or decrease the incidence of a particular genetic predisposition in a population. A simple genotyping experiment is not very difficult to perform and is also not particularly expensive. However, with increasing numbers of samples the expenses rapidly increase. In order to reduce at least the number of tests and thereby save costs the invention provides a method for genotyping a first polymorphic locus in at least two organisms from one species in an assay, said method comprising

providing from each of said at least two organisms an individual sample comprising nucleic acid of said organism

and

pooling said individual samples such that the ratio of the amounts of nucleic acid of said at least two organisms in the pool allows for the assay to discriminate between the frequencies of occurrence of each variant allele of

said first polymorphic locus in said assay,

said method further comprising

measuring the frequency of occurrence of at least one of said variant alleles in said pooled sample

and;

determining from said measured frequency, the genotypes of said at least two organisms for said first polymorphic locus. In a preferred embodiment of typing one or polymorphic loci said nucleic acid comprises DNA. With a method of the invention it is possible to determine the genotype of essentially all individuals represented in the pool. With the term “polymorphic locus” is meant that the same position or locus in the genome of an individual organism of a species can have two or more possible alleles (A, B etc.). A polymorphism can be the presence of different gene variants at this site, however, often it concerns single nucleotide polymorphisms or SNP. These SNP are typically used in combination with traits that are more or less strictly associated with the SNPs. A variant allele is one of the alleles that are possibly present at the polymorphic locus. In the SNP example this is one of the different nucleotides that are possible for the SNP at the locus.

As the assay can discriminate between the frequencies of each variant allele of the polymorphic locus in the pool, it is possible to determine the genotype of the different organisms that were represented in the pool. The possible frequencies of occurrence of the variant allele in the pool are the different result points that are attainable for that variant allele depending on the representation of the different samples in the pool and the number of different variant alleles that are potentially present in the locus. The frequency of occurrence of the variant allele in the pool can be measured in various ways. Typically though not necessarily the occurrence of an allele in the pool is detected by means of a signal that is specific for the variant allele in the sample. The signal is preferably quantitated. The signal can be any signal as long as it can be quantitated. Preferably the signal is a fluorescence signal. The detected signal is quantitated and from this the frequency of occurrence of the variant allele in the pool is determined. This frequency is then subsequently used to determine the genotype of the organism at the particular locus.

In a preferred embodiment the assay comprises a reference in which the frequency of at least one of said variant alleles of said first polymorphic locus is known. The reference signal provides a standard with which the detected signal for the variant allele can be compared. This comparison provides a more accurate determination of the frequency of the variant allele in the pool. The reference can be a separate sample that is processed and analysed in parallel with the test sample that represents the pool of individual samples. The detection level of the assay is preferably set such that essentially all measurement point, “result points” or potential frequencies of the allele give a signal that is above the detection limit of the assay. The assay also works when not all measurements points are above the detection limit of the assay. For instance, a first allele is not detected the signal can be zero or below the detection limit. In this case the detection of a second allele allows determination of the frequency of that allele in the pool. The genotypes can, in some embodiments, thus be established on the basis of the results of the second allele or, alternatively, the frequency of the first allele is inferred from the frequency of the second allele. This is for instance possible in an embodiment where there are two different variant alleles for the polymorphic locus.

Although very accurate mixing of the different samples in a pool of the invention is possible, it can occur that the actual ratios with which the individual samples are represented in the pool differs from the ratios intended. This can, for instance, occur when sample DNA is highly viscous and accurate pipetting is difficult. It can also happen that DNA measurement in the sample is inaccurate as a result of contaminants present therein (for instance RNA) or when the method of measuring DNA concentration does not allow a wide enough range of concentrations to be measured with the same high accuracy. It can also happen when the actual pooling is not done on the basis of DNA quantities in the individual samples but rather on the basis of some other characteristic of the individual sample, e.g. volume, weight, estimated number of nucleated cells, etc. That the actual ratio of the individual samples in the pool is different from the intended ratio is easily detected. In this case, the detected signal may not be correctly allocated to one of the result points which are defined on the basis of the intended pooling ratio. If this is the case the detected signals are used to fit the actual ratios with which the individual samples are represented in the pool. This actual ratio can be used, for instance, to determine the genotypes of polymorphic allele in the organisms represented in the pool. Thus in a preferred embodiment a method of the invention further comprises determining a difference between the measured frequency of occurrence of at least one of said variant alleles and the frequency thereof expected as a result of the pooling of said individual samples. In a preferred embodiment the method further comprises determining from said difference the actual ratio's of DNAs of at least two of said at least two organisms in the pool.

Determining the actual ratio with which the individual samples are represented in the pool becomes more accurate when the pool is used to determine the genotype of several polymorphic loci in the organisms represented in the pool, or similarly when the pool is used to type nucleic acid at several positions The results signals detected for various alleles of the different loci, or positions are used to arrive at the actual ratio with which the individual samples are represented in the pool. This ratio is then subsequently used. Preferably to determine the genotypes at the polymorphic loci used to arrive at the actual ratio or used to determine the genotypes at yet further polymorphic loci in the organisms represented in the pool. Thus in a preferred embodiment a method of the invention comprises genotyping a second polymorphic locus in said at least two organisms in said assay. Preferably said method comprises measuring the frequency of occurrence of at least one variant allele of said second polymorphic locus in said pooled sample and determining from said at least one measured frequency, the genotypes of said at least two organisms for said second polymorphic locus. As indicated herein above, it is preferred that the genotypes of said at least two organisms for said second polymorphic locus is determined using the actual pooling ratio's of DNA of at least two organisms in said pool.

A pool of the invention pool can be generated in various ways. This is not critical as long as there is reasonable control over the ratios with which the DNA of the individual samples is represented in the pool. Pooling can be done in several ways but accuracy depends on the method used. Simplest pooling can be done based on tissues samples or blood. Pooling ratio can be based on grams of tissue, grams of blood or volume of blood. To be more accurate cells of tissue could be suspended and counted. For birds blood packed cell volume or hemoglobin content could be measured.

After pooling based on weight units, volume or cell counts DNA can be extracted from the pool. Also DNA can be extracted from the original individual samples separately and then pooled based on DNA concentration measurements. Several methods (kits) are available to measure DNA concentration. Pooling can be done based on these concentrations. Sometimes DNA is normalized (diluted so that all samples have the same concentration) and then pooled based on volume or weight.

So three steps of pooling

1) based on volume or weight units

2) based on cell counts

3) based on DNA concentration and volume or weight

Target would be to get a ratio between DNA quantity of sample 1 and DNA quantity of sample 2 of 1:3. In a preferred embodiment the pool is generated by mixing DNA of the individual samples. In another preferred embodiment the pool is generated by pooling cells of the respective organisms in the pool. Thus in a preferred embodiment said pooled sample is obtained by pooling cells of said at least two organisms.

The inventors have shown that this principle can be used for a large number of analyses involving a quantitative measurement of an analyte in a sample, wherein the result of the analysis is categorical with respect to a quality of the analyte in said sample.

In a first aspect, the present invention now provides a method of pooling samples to be analyzed for a categorical variable, wherein the analysis involves a quantitative measurement of an analyte, said method of pooling samples comprising providing a pool of n samples wherein the amount of individual samples in the pool is such that the analytes in the samples are present in a molar ratio of x⁰:xⁱ:x⁽ⁿ⁻¹⁾, and wherein x is the pooling factor, and is equal to a positive value other than 1 and n is the number of samples. The annotation x⁰:xⁱ:x⁽ⁿ⁻¹⁾ should be understood as referring to a geometric series of n elements where x⁰ is the first element and there are n−1 subsequent elements generated by xⁱ where i is an incremental integer having a value between 1 and n−1. As indicated herein above the formula presented can be used to more quickly arrive at suitable pools. Pooling of individual samples is preferably such that the intended ratio of the quantities of DNA of said at least two organisms in the pool allows for the assay to discriminate between the frequencies of occurrence of each variant allele of said first polymorphic locus in said assay. Suitable pooling factors are preferably higher than 2.1, more preferably higher than 2.5. In a particularly preferred embodiment said pooling factor is 3. Higher values are also possible but are preferably lower than 5 or more preferably lower than 4. However, pooling factors of a positive value lower than 1 are also possible and a value higher than 1 and lower than 2 is also possible. A ratio of 1:1 will typically not be possible except when as a result of the intended mixing of 1:1 an error is made resulting a ratio other than 1:1, for instance, 1:1.5.

According to the invention a method of the invention does not involve pooling of samples to be analyzed for a categorical variable, wherein the analysis involves a quantitative measurement of an analyte, said methods of pooling samples comprising providing a pool of n samples wherein the amount of individual samples in the pool is such that the analytes in the samples are present in a molar ratio of x⁰:xⁱ:x⁽ⁿ⁻¹⁾, and wherein x is an integer of 2 or higher representing the number of classes of the categorical variable. The numeral “n” represents the number of samples.

When x represents the pooling factor, n is the number of samples and the expression is to be understood as referring to a geometric series of n elements where x⁰ is the first element and there are n−1 subsequent elements generated by xⁱ where i is an incremental integer having a value between 1 and n−1.

For pooling polyploid individuals the pooling factor x is ideally (for optimal accuracy of measurement) equal to the (ploidy level+1), so x=2 for a haploid, 3 for a diploid and 5 for a tetraploid individual with two possible alleles at one single position, the pooling factor x is thus preferably (but not necessarily) equal to the number of possible genotypes (i.e. the possible combinations of alleles in one individual). In practise, however, such accurate pooling factors can hardly be achieved. The present invention therefore provides methods and means wherein either other pooling factors are chosen or other pooling factors arise from, e.g. errors or inaccuracies in pooling. Below the ideal (theoretical) situation is among others further exemplified.

Assume there would be three possible alleles, then a haploid would have 3 possible genotypes (g=3), a diploid would have 6 possible genotypes (g=6) and a triploid would have 10 possible genotypes (g=10). In one diploid individual the first allele can occur 0, 1 or 2 times just as the second and third allele. This makes it possible to pool in the same ratio x⁰:xⁱ:x⁽ⁿ⁻¹⁾) as with two alleles (the pooling factor x again ideally being the polyploidy level +1). Signal intensities for the 3 alleles are rounded to the nearest result point which is zero or 1 to (p+1)ⁿ multiples of (1/((p+1)ⁿ−1)*100%, where p=ploidy level and n=number of samples) to find the number of occurrences of alleles in the pooled sample.

Instead of signal intensities for the A and B allele (e.g. red and green intensities) we now need to measure intensities for A, B and C.

Methods wherein the amount of the individual samples in the pool is provided as geometric sequence with common ratio 3 (or any other positive value other than 1 that provides sufficient accuracy of measurement) are particularly suitable for genotyping bi-allelic variants in diploid individuals, wherein each individual has three possible genotypes. The genotype is the combination of two categorical traits with two classes each (present or absent) which may have three possible results (AA, AB and BB).

Methods wherein the amount of the individual samples in the pool is provided as geometric sequence with common ratio 2 (or any other positive value other than 1 provided that there is sufficient accuracy of measurement) are particularly suitable for genotyping an bi-allelic variant in haploid individuals. For an example thereof, reference is made to the experimental part below. The term “sufficient accuracy of measurement” herein refers to the fact that the quantitative measurement allows for discrimination between result points.

In another aspect, the present invention relates to the use of a method of the invention as described above, for genotyping an bi-allelic variant in haploid or polyploid individuals wherein the number of combinations of classes of the categorical variable equals p+1, wherein p represents the ploidy level of said individual. Such use for instance allows for genotyping an allelic variant in a diploid or haploid individual.

In yet another aspect, the present invention relates to a method of performing an analysis on multiple samples, comprising pooling said samples according to a method of the invention as described above to provide a pooled sample and performing said analysis on said pooled sample. The quantitative result obtained is then rounded off to the nearest result point (determined by the number of theoretical intervals in which maximum sample signal strength is divided for each possible result, see infra), and the signal intensity is allocated to one of the total number of combinations of classes of the categorical variables measured in the pooled sample. From this the categorical variables are determined for each individual sample in the pool taking into account the ratio of the various individual samples in the pool.

In another aspect, the present invention provides a method of performing an analysis on multiple samples, comprising performing an analysis on a set of pooled samples obtained by a method of pooling samples as defined herein above, wherein said sample is analyzed for one or more categorical variables and involves quantitative measurements of analytes in said sample.

In a preferred embodiment of this method, a method of performing an analysis further comprises the step of deducing from the measurement the contribution of the individual samples in said pool of samples.

In another aspect, the present invention provides a pooling device for pooling multiple samples into a pooled sample comprising a sample aspirator for providing a pooled sample and further comprising a processor for performing a method of pooling samples as defined herein above.

In another aspect, the present invention provides an analysis device comprising a processor that is arranged for performing an analysis on a set of pooled sample obtained by a method of pooling samples as defined herein above, wherein said device is arranged for analysing said sample for a categorical variable and for performing a quantitative measurement of an analyte in said sample.

In a preferred embodiment of this analysis device, the device further comprises a pooling device, most preferably a pooling device as disclosed above.

In another aspect, the present invention provides a computer program product either on its own or on a carrier, which program product, when loaded and executed in a computer, a programmed computer network or other programmable apparatus, puts into force a method of pooling samples as defined herein above.

In another aspect, the present invention provides a computer program product either on its own or on a carrier, which program product, when loaded and executed in a computer, a programmed computer network or other programmable apparatus, puts into force a method for performing an analysis on multiple samples, said method comprising performing an analysis on a set of pooled sample obtained by a method of pooling samples as defined herein above, wherein said sample is analyzed for a categorical variable and involves a quantitative measurement of an analyte in said sample.

In a preferred embodiment of this computer program product, the said method further comprises the step of pooling according to a method of pooling samples as defined herein above.

By using the method of the present invention analysis costs can be reduced immensely, i.e. typically by 50%, and even by 66% or more.

The term “categorical variable”, as used herein, refers to a discrete variable such as a characteristic or trait, e.g. the presence or absence of an analyte or a characteristic therein, or an allelic trait present or absent in homozygous or heterozygous form in an analyte. Discrete is synonymous for categorical and refers to non-linear or discontinuous. A “variable” generally refers to a (categorical) trait measuring a property of a sample. A categorical variable can be binary (consisting of 2 classes). A “class” refers to a group or category to which a measurement can be assigned. Thus, a purely categorical variable is one that will allow the assignment of categories and categorical variables take a value that is one of several possible categories (classes). In particular, the categorical variable may relate to the presence of a genetic marker such as a single nucleotide polymorphism (SNP) or any other genetic marker, an allele, an immune response, a disease, a resistance capacity, hair color, gender, status of disease infection, genotype or any other trait or property of a sample or biological entity. Although they can be measured numerically, for instance as a generated analyte-signal that can be received, read and/or recorded by an analysis device, categorical variables themselves have no numerical meaning and the categories have no intrinsic ordering. For example, gender is a categorical variable having two categories (male and female often coded as 0 and 1) and represent preferably unordered categories. Genotype is also a categorical variable having a number of preferably unordered categories (AA, Aa and aa sometimes coded as 2, 1 and 0).

The sample in aspects of the present invention may be any sample wherein a categorical variable is to be measured. The sample may be a biological sample such as a tissue or body fluid sample of an animal (including a human) or a plant, an environmental sample such as a soil, air or water sample. The sample may be (partially) purified or may be an untreated (raw) sample. The sample is preferably a nucleic acid sample, for instance a DNA sample. Preferably the sample is not a trio, meaning that the sample preferably does not consist of samples from, for instance, two parent individuals and one of their offspring (a father, a mother and a child) whereby two pools each consisting of one parent and the offspring individual are created (father+child and mother+child).

The analyte whose presence or form is measured in a quantitative test may be any chemical or biological entity. In preferred embodiments, the analyte is a biomolecule and the categorical variable is a variant of said biomolecule. Preferably, the biomolecule is a nucleic acid, in particular a polynucleotide, such as RNA, DNA and the variant may for instance be a nucleotide polymorphism in said polynucleotide, e.g. an allelic variant, most preferably an SNP, or the base identity of a particular nucleotide position.

The analyte as defined herein can thus be a DNA molecule exhibiting a certain categorical variable (e.g. the base identity of a particular nucleotide position in that nucleic acid molecule, having a categorical value of A, T, C or G). The base identity of a particular nucleotide position can be measured by using a quantitative test, for instance based on fluorescence derived from a cDNA copy incorporating a fluorescent analogue of said nucleotide, such as known in the art of DNA sequencing. The quantitative level of the fluorescence emitted by said analogue in a particular position of the DNA and measured by an analysis device, is then assigned to a categorical value for that nucleotide position, e.g. as an Adenine for that position.

In determining the base identity of a particular nucleotide position, the invention pertains to pooling of individual samples of which the nucleotide sequence of a particular nucleic acid is to be determined. The suitability of the method of the invention for sequencing assays (analyses) can be understood when realizing that sequencing assays involve the determination of a signal from either one of four possible bases wherein the presence or absence of a signal for any particular base at a certain position in for instance a sequencing gel corresponds to the presence or absence of that base identity in a particular nucleotide position within said nucleic acid. Pooling of two samples before running the sequence gel in the ratio as described herein will allow determination of the origin of any particular signal and thus of the sequence for each individual nucleic acid.

The “analyte” may be a polypeptide, such as a protein, a peptide or an amino acid. The analyte may also be a nucleic acid, a nucleic acid probe, an antibody, an antigen, a receptor, a hapten, and a ligand for a receptor or fragments thereof, a (fluorescent) label, a chromogen, radioisotope. Fact, the analyte can be formed by any chemical or physical substance that can be measured quantitatively, and that can be used to determine the class of the categorical variable.

The term “nucleotide”, as used herein, refers to a compound comprising a purine (adenine or guanine) or pyrimidine (thymine, cytosine or uracyl) base linked to the C-1-carbon of a sugar, typically ribose (RNA) or deoxyribose (DNA), and further comprising one or more phosphate groups linked to the C-5-carbon of the sugar. The term includes reference to the individual building blocks of a nucleic acid or polynucleotide wherein sugar units of individual nucleotides are linked via a phosphodiester bridge to form a sugar phosphate backbone with pending purine or pyrimidine bases.

The term “nucleic acid” as used herein, includes reference to a deoxyribonucleotide or ribonucleotide polymer, i.e. a polynucleotide, in either single-or double-stranded form, and unless otherwise limited, encompasses known analogues having the essential nature of natural nucleotides in that they hybridize to single-stranded nucleic acids in a manner similar to naturally occurring nucleotides (e.g., peptide nucleic acids). A polynucleotide can be full-length or a subsequence of a native or heterologous structural or regulatory gene. Unless otherwise indicated, the term includes reference to the specified sequence as well as the complementary sequence thereof. Thus, DNAs or RNAs with backbones modified for stability or for other reasons are “polynucleotides” as that term is intended herein. Moreover, DNAs or RNAs comprising unusual bases, such as inosine, or modified bases, such as tritylated bases, to name just two examples, are polynucleotides as the term is used herein.

The term “quantitative measurement” refers to the determination of the amount of an analyte in a sample. The term “quantitative” refers to the fact that the measurement can be expressed in numerical values. The numerical value may relate to a dimension, size, extent, amount, capacity, concentration, height, depth, width, breadth, length, weight, volume or area. The quantitative measurement may involve the intensity, peak height or peak surface of a measurement signal, such as a chromogenic or fluorescence signal, or any other quantitative signal. In general, when determining the presence or form of an analyte, the measurement will involve an instrument signal. For instance, when determining the presence of an SNP, the measurement will involve a hybridization signal, and the measurement will typically provide a fluorescence intensity as measured by a fluorimeter. When determining the presence of an immune response, the measurement will involve measurement of an antibody titer and the measurement may also be typically provided as a fluorescence intensity. The measurement need not provide a continuous measurement result, but may relate to discrete intervals or categories. The measurement may also be semi-quantitative. As long as a the measurement can be determined in 2ⁿ−1 3ⁿ−1 or xⁿ−1 partial and preferably proportional intervals of the maximum sample signal strength (depending on whether the pool is provided as geometric sequence with common ratio 2, 3 or x, respectively, wherein n is the number of samples in the pool, x is the pooling factor and has a positive value not equal to 1)the measurement is in principle suitable.

The term “pooling”, as used herein, refers to the grouping together or merging of samples for the purposes of maximizing advantage to the users. In particular the term “pooling” refers to the preparation of a collection of multiple samples to represent one sample of weighted value. Merging of multiple samples into one single sample is usually performed by mixing samples. In the present invention, mixing requires a careful weighing of the amount of the individual samples, wherein the amount of analyte present in each sample is decisive. When a sample A has an amount of analyte of 2 g/l and sample B has an amount of 1 g/l, these samples have to be pooled in a volume ratio of 1:6 in order to provide the 1:3 analyte ratio.

The term “pooling factor” refers to the ratio at which the amounts of analyte in the various samples in the pool are provided relative to each other. The pooling factor may have a value above 1, for instance 1.25, 1.5, 2, 3, 4, 4.78, etc. Alternatively, the pooling factor may have a value below 1, for instance 0.90, 0.5, or 0.33.

When two samples are e.g. pooled in a ratio of 1:3 or when three samples are pooled in a ratio of 1:3:9 as prescribed in embodiments of the present invention, the possible frequencies of occurrence of the variants in the pools is set by the endpoints of intervals of 12.5% and 3.85%, respectively. The endpoints of these intervals are referred to herein as the “result points” and are equivalent to the step increments of the quantitative measurement up to reaching maximum sample signal strength.

The terms “geometric sequence” and “geometric series” refer to a sequence of numbers in which the ratio between any two consecutive terms is the same. In other words, the next term in the sequence is obtained by multiplying the previous term by the same number each time. This fixed number is called the common ratio for the sequence. In a geometric sequence of the present invention, the first term is 1 and the common ratio is 2 or 3, depending on the sample type.

The term “maximum sample signal strength” refers to the signal obtained from the pool when all samples in that pool provide a positive signal, i.e. when 100% of the individual samples are positive for the tested analyte. The maximum sample signal strength can be determined by any suitable method. For instance, 50 individual samples can be measured separately to determine their composition in terms of the number of discrete events present among these samples, and subsequently these samples may then be measured in a pooled experiment, wherein the signal strengths measured for the pooled sample are showing in the same proportion that would be obtained by adding up all signal strengths of all individual samples.

A method of the present invention may be performed with any number of n samples. However, in practice, the maximum number for n is set by the accuracy of the measurement method, i.e. the accuracy with which a statistically sound distinction between two consecutive result points can be determined. The accuracy (standard deviation) of the method must be in accordance therewith.

Applications of the method of the present invention include, but are not limited to, genotyping methods. Genotyping based on pooling of DNA has many applications. Genotypes can be used for mapping, association and diagnostics in all species. Specific genotyping examples include a) genotyping in humans, such as medical diagnostics but also follow-up individual typings following case—control study poolings; b) genotyping in livestock, such as individual typings in QTL studies, in candidate gene approaches, in marker assisted selection programs and genome wide selection applications, and c) genotyping in plants e.g. for mapping and association studies, for marker assisted selection programs and genome wide selection applications.

Pooling can also be used when sequencing humans, livestock, plants, bacteria, viruses. More specifically pooling of individual samples for sequencing is relevant when sequences of two or more individuals are to be compared.

A method of the present invention for pooling samples comprises the taking of a subsample from at least a first sample and a subsample from at least a second sample, wherein said first and second subsample are merged into a single container as to provide a mixture of the two subsamples in the form of a pooled sample and wherein the ratio of said first and second subsamples in said pooled sample is for instance 1:3 or 3:1, 3 being the pooling factor based on the analyte concentration in the samples as described herein. Similarly, when three samples are pooled (which phrasing refers to the fact that three subsamples are mixed) the ratio between the first, second and third subsample (in any order) to be obtained in the pooled sample is for instance 1:3:9, again relating to a pooling factor of 3 as described herein. The possible frequencies of the variants in the pools is set by the endpoints of intervals of, in this case, 12.5% and 3.85%, respectively. The endpoints of these intervals are referred to herein as the “result points” and are equivalent to the step increments up to reaching maximum sample signal strength. The pooling factor is in certain preferred embodiments a positive value not equal to 1. In other preferred embodiments, the pooling factor approached the ideal value for accuracy of the measurement, as explained above. Hence, it is preferably 3 when analysing two alleles in a sample when there are three possible combinations of the two alleles.

A method of pooling as defined herein may be performed by (using) a pooling device. Such a device suitably comprises a sample collector arranged for collecting and delivering a defined amount of sample, for instance in the form of a defined (but variable) volume. A suitable sample collector is a pipettor such as generally applied in robotic sample delivery and processing systems used in laboratories. Such robotics systems are usually bench-top apparatuses, suitably comprising one or more of a microplate processor stages, reagent stations, filter plate aspirators, and robotic pipetting modules based on pneumatics and disposable pipette tips. These sample robot systems are very suitable for performing the method of the present invention as they are ultimately designed to combine different liquid volumes from different samples into one or more reaction tubes. Therefore, it is within the level of skill of the artisan to adapt such a pipetting robotic system to perform the task of combining different liquid volumes from different samples into a single pooled sample. Such a pipetting robotic system is however only one suitable embodiment of a sample pooling device for of pooling multiple samples into a pooled sample, said device comprising a sample collector for collecting samples from multiple sample vials and for delivery of samples into a single pooling vial to provide a pooled sample, and further comprising a processor that is arranged for performing a method of pooling samples as defined herein. The term “processor”, as used herein, is intended to include reference to any computing device in which instructions stored and retrieved from a memory or other storage device are executed using one or more execution units, such as a unit comprising a pipetting device and a robotics arm for moving said pipetting device between sample vials and pooling vials of a pipetting robotic system. The term vial should be interpreted broadly and may include reference to an analysis spot on an array. Processors in accordance with the invention may therefore include, for example, personal computers, mainframe computers, network computers, workstations, servers, microprocessors, DSPs, application-specific integrated circuits (ASICs), as well as portions and combinations of these and other types of data processors. Said processor is arranged for receiving instructions from a computer program that puts into force a method of pooling samples according to the present invention on a pooling device as defined herein above. Such a method relates in a preferred embodiment to a method of pooling samples to be analyzed for a categorical variable, wherein the analysis involves a quantitative measurement of an analyte, said method of pooling samples comprising providing a pool of n samples wherein the amount of individual samples in the pool is such that the analytes in the samples are present in a molar ratio of of x⁰:xⁱ:x⁽ⁿ⁻¹⁾, and wherein x is the pooling factor, and is equal to a positive value other than 1, n is the number of samples and the expression is to be understood as referring to a geometric series of n elements where x⁰ is the first element and there are n−1 subsequent elements generated by xⁱ where i is an incremental integer having a value between 1 and n−1.

While the method of pooling is quite straightforward, and can be described in terms of relatively simple formula's, the method of analysis of pooled samples as described herein is more intricate.

As described herein, a categorical variable (e.g. genotype) may take a value that is one of several possible categories (BB, AB, AA). These categories coincide with classes of result intervals. The categories are determined by performing a quantitative measurement on an analyte (DNA) for a parameter (e.g. fluorescence), and assigning classes to these parameter values based on categorization of analysis results, each of which classes represents a variant for said categorical variable (See FIG. 7).

In general, the total number of possible analysis results (outcomes) depends on the nature of the categorical variable which may vary. For instance in the case of a genotype of a diploid organism, the ploidy level determines the number of possible analysis results. In general terms, the nature of the categorical variable can include the presence of different numbers of variants or sets of the analyte (repeats in FIG. 7) within a sample. Also, the total number of possible analysis results depends on the number of possible variants of one repeat. An example of the number of possible analysis results is provided in Table 1.

TABLE 1
Total number of possible analysis results (outcomes) for a
measurement when this is composed of repeats of the same event.

| Possible | | | | |
|---|---|---|---|---|
| Values for one | Number of repeats within a sample (k) | | | |
| repeat (n) | 1 | 2 | 3 | 4 |
| 2 | 2 | 3 | 4 | 5 |
| 3 | 3 | 6 | 10 | 15 |
| 4 | 4 | 10 | . . . | . . . |
| 5 | 5 | 15 | . . . | (^{n +} ₖ^{k -} ¹⁾ ) |

n represents the number of variants for one repeat such as the number of alleles at 1 locus and k is the number of repeats within the sample such as the ploidy level (p). The values provided in the table are the number of possible analysis results such as the genotypes (g); they are calculated based on the formula (n+ₖk−1).

For instance, the possible number of results of the genotype of a diploid individual (2 [k] repeats of a bi-allelic locus within one sample) is equal to 3 (AA, AB and BB) because one allele can have only two [n] different variants (A or B). A triploid (3 [k] repeats of one bi-allelic locus) can have 4 different genotypes (AAA, AAB, ABB and BBB).

A blood group for an individual is one repeat [k] having four different variants ([n]; A, B, AB or O).

The formula in table 1 holds for situations were it is not important for which repeat the variant is measured. For instance, for genotyping there is no difference between genotype AB and genotype BA. However, in case the identity of the repeat is important then the formula for calculating the total number of possible analysis results is nk. This formula then replaces the formula (n+ₖk−1) in Table 1. Also all values in the table change accordingly. For a situation with 2 repeats and 2 possible categorical values or variants per repeat there will be 4 results. With 3 repeats and 3 possible variants per repeat there will be 9 different results.

The total number of possible analysis results is applied herein as pooling ratio (e.g. 1:3:9) and directly provides what is called the “pooling factor” (3 in the case of 1:3:9). For instance when pooling haploid individuals for genotyping there is one repeat having 2 possible variants per repeat. In such cases the pooling factor is preferably equal to 2 (is number of results in table 1).

Pooling 4 individuals is then preferably done in the ratio 2⁰:2¹:2²:2³.

When pooling diploid individuals the pooling factor is preferably 3.

Pooling 3 individuals is then preferably done in the ratio 3:3¹:3².

The total number of results in a pool then is equal to following formula;

Total pool results=number of possible individual genotypes^{number of samples}.

The optimal increment for the signal intensities is then equal to;

Increment=1/(number of possible individual genotypes^{number of samples}−1)*100%

or

1/((g)ⁿ⁻1)*100%,

where n is the number of samples and g is the number of genotypes.

If measurement intensities are present for all variants for one repeat (are all values minus one because the missing one can then be calculated as 1 minus intensities for the other) the top row in Table 1 is followed because this can be seen as present or absent for every value of that repeat which corresponds to 2 possible outcomes for this repeat. See example above where 3 possible alleles are assumed instead of 2 and where one can measure 3 different light intensities in stead of 2 (red and green).

If there is only a single measurement table 1 can be followed.

A method of the present invention for analysing pooled samples as contemplated herein comprises the performance of a measurement for the required analyte on said pooled sample. Upon recording of a measurement result, for instance an instrument signal, the analysis then involves a series of steps that is exemplified in great detail in the Examples provided herein below.

Performing an analysis on a set of pooled sample obtained by a method of the invention wherein said sample is analyzed for a categorical variable, involves a quantitative measurement of an analyte in said sample. The analyte is a chemical or physical substance or entity or a parameter thereof which is indicative for the presence or absence of at least one variant of said categorical variable. For instance, when determining as a categorical variable the genotype of an organism, having variant alleles A or B, the analyte is the organism's DNA, a DNA probe or a genetic label and the absolute value of a parameter of that analyte may be correlated directly to the presence (or absence) of the variant. The quantitative measurement for the analyte will generally involve a fluorescence intensity, a radioisotope intensity, or any quantitative measurement as a value for the analyte parameter. Measurement values beyond a certain threshold or categorical value will generally indicate the presence of the variant. Quantitative measurement of an analyte in a sample thus refers to an analyte signalling the presence or absence of a variant of that categorical variable which is to be analyzed in said sample.

Essentially, in a method of analysing a pooled sampled obtained by a method of pooling samples as described herein, the contribution of the individual samples in said pool, that is, the result for the individual samples in the pool, is determined as follows.

First the maximum sample signal strength for a certain analysis “A” to be performed on a pool of n samples is determined and set at 100% signal. The maximum sample signal strength is the signal strength that is attained when 100% of the samples in a pool of n samples is positive for the categorical variable. The maximum sample signal strength can be determined by providing a test-pool of n positive reference samples and determining the measurement signal, wherein said positive reference samples are positive with regard to the categorical variable, and wherein n is the number of samples in the pools on which analysis “A” is performed. The maximum sample signal strength for analysis “A” is recorded or stored in computer memory for later use. Next, the analyte of interest is measured in a pooled sample obtained by a method of the present invention by performing analysis “A”, whereby the signal strength of the pooled sample for the analyte is determined. The resulting signal strength for the analyte in the pooled sample is recorded, rounded off to the nearest result point as defined above and optionally stored, and then compared to the maximum signal strength. Suitably, this comparison can be performed as follows. In general, taking a pooling factor of 3, identical to the number of combinations of two variants with two possible categorical values each, each possible and optimal measurement result can be allocated to a single value which is zero, one, two, three, four, five, six, seven or eight-eighth (⅛) of 100% of maximum sample signal strength. In general: each possible measurement result can be allocated to a value which is zero or a multiple of 1/((p+1)ⁿ−1)*100%, wherein n is the number of samples in the pool, p is the ploidy level and 100% is the maximum sample signal strength for the categorical variable. For instance for p=2 and a pool of 4 samples, with the maximum sample signal strength set at 100% using 4 positive reference samples, there are in total (2+1)⁴=3⁴=81 result points, wherein each possible measurement result can be allocated to zero or a value ⅛*100%=1.25% or anyone of up to 80 multiples thereof.

The result for each sample in a pool of samples can be read from a simple result table, which can be stored in computer readable form in a computer memory, and which table allocates for each optimal result point of incremental steps of 1/((p+1)ⁿ−1)*100% between 0% and 100% of the maximum sample signal strength the corresponding value for each individual sample in the pool. For instance such a result table is the table as provided in Table 2 below.

The analysis is completed by assigning to each of the various subsamples in said pooled sample the class of the categorical variable(s).

A method of analysing a pooled sample as defined herein may be performed by an analysis device. An analysis device of the present invention comprises a processor that is arranged for performing an analysis on a set of pooled sample obtained by a method for pooling samples as described above, wherein said device is arranged for analysing said sample for a categorical variable and for performing a quantitative measurement of an analyte in said sample. As noted above, the unique feature of the analysis device is that it is arranged for analysing a pooled sample for a categorical variable in each individual sample in said pool and for performing a quantitative measurement of an analyte in said sample. Essentially, the analysis device is arranged for measuring and analysing the measurement result obtained for the pooled sample and inferring from that result the categorical variable in each individual sample in a pool. Such a device suitably comprises a signal-reading unit for measurement of the analyte signal in the pooled sample. The analysis device further suitably comprises a memory for storing the measurement result and the result table as described above. The analysis device further suitably comprises a processor arranged for retrieving data from memory and/or from the reading unit, and arranged for performing a calculation and for performing an iterative process wherein the measurement result for the pooled sample are compared with and allocated to the corresponding results for the individual samples in said pool using the above referred result table; an input/output interface for entering sample data into the memory or processor; and a display connected to said processor. The processor is arranged for receiving instructions from a computer program that puts into force a method of analysing samples according to the present invention on an analysis device as defined herein above. The term “processor” as used herein is intended to include reference to any computing device in which instructions retrieved from a memory or other storage device are executed using one or more execution units, such as a signal reading unit for receiving a pooled sample and for performing the measurement of an analyte by determining the signal of said analyte in a sample or a pooled sample.

An analysis device of the present invention may further include the pooling device of the invention.

The invention further provides a computer program product either on its own or on a carrier, which program product, when loaded and executed in a computer, a programmed computer network or other programmable apparatus, puts into force a method of pooling samples as described above. Essentially, the computer program product may be stored in the memory of the pooling device of the invention and may be executed by a processor of said device by providing said processor with a set of instructions corresponding to the various process steps of the method of pooling.

The invention further provides a computer program product either on its own or on a carrier, which program product, when loaded and executed in a computer, a programmed computer network or other programmable apparatus, puts into force a method for performing an analysis on multiple samples, said method comprising performing an analysis on a set of pooled sample obtained by a method of pooling samples as described above, wherein said sample is analyzed for a categorical variable and involves a quantitative measurement of an analyte in said sample. Essentially, the computer program product may be stored in the memory of the analysis device of the invention and may be executed by a processor of said device by providing said processor with a set of instructions corresponding to the various process steps of the method of analysis. In the computer program product for performing an analysis, the method embedded in the software instructions may further comprises the step of pooling samples as described above.

The present invention will now be illustrated by way of the following non limiting examples.

### EXAMPLES

### Example 1

Example of Using the Pooling Procedure for Genotyping of Diploid Individual Samples for the Presence of SNPs Using 50 Individual Samples and 1 Pool of 50 Individuals for Finding the Correction Factors.

Step 1) 50 individuals were Tested Separately.

For every SNP and every individual we obtained an intensity for red fluorescence (presence of A allele) and green fluorescence (absence of A allele =presence of B allele) using two different fluorochromes in a microarray format. The ratio between red and green intensities is not always 1 (or 0) for a homozygous animal or 0.5 for a heterozygous animal.

The data on individual genotypings were used to calculate the correction factors from the signal intensities for all typed SNPs.

To obtain the most important correction factor (K), a correction factor often used to correct the data for any unequal efficiencies in representing the alleles, we used signals from heterozygous genotypes. If heterozygous genotypes were not present, we assumed that the SNP studied is not segregating in the population under research and therefore results for this SNP in the pools should be omitted.

Omission of SNPs due to absence of heterozygotes in the sample of 50 individuals may have as a consequence that information on SNP's with low MAF (minor allele frequency) could be lost. For many applications this is not harmful because SNPs with very low minor allele frequencies do not contribute very much to the accuracy and a decision then can be made not to use data on these SNPs or not to apply the correction factor.

The first correction factor (K) we used was;

K=avg (Xraw/Yraw)

wherein Xraw is the measured intensity for red, and Yraw is the measured intensity for green. This value was determined from the individually genotyped samples with genotype AB.

Instead of using the average result of all beads for one genotype we also can use the results of all the separate beads. So from one sample we use the average result for Xraw and Yraw or for X and Y or we use the results of all separate beads from that sample.

If heterozygous genotypings are not present we can ignore the SNP in further samples as mentioned earlier or assume K=1.

The other correction factors are AAavg and BBavg. AAavg is the average of the uncorrected A-allele frequencies of AA genotypes. This value is expected to be close to 1. BBavg is the average of the uncorrected A-allele frequencies of BB genotypes. This value is expected to be close to 0. AAavg and BBavg were calculated using the formulas:

AAavg=(avg(Xraw/(Xraw+Yraw)))

and

BBavg=(avg(Xraw/(Xraw+Yraw)))

Step 2) One testpool was constructed including all 50 individuals from step 1 above. To this end DNA concentration in ng/μl was measured in each individual sample using a NanoDrop spectrophotometer (NanoDrop Technologies, USA). All DNA samples were then diluted to a standard concentration of 50 ng/μl before pooling into a single sample. In the testpool we thus obtained estimated allele frequencies either uncorrected or based on the correction factors found in the first step.

Uncorrected allele frequency for allele A is calculated as a ratio between red intensity divided by the sum of both intensities as follows:

Uncorrected allele frequency=Xraw/(Xraw+Yraw)

The first correction for allele frequency we applied was

Corrected allele frequency=Xraw/(Xraw+K*Yraw)

The second correction we applied was a normalization.

Normalized allele frequency=(Corrected allele frequency−BBavg)/AAavg

For both correction and normalization we used all 3 genotypes for every SNP separately from the individual samples.

The order of accuracy of estimated allele frequencies was: normalized (most accurate), corrected (in between) and uncorrected (least accurate).

This means that if there were no heterozygous individuals in step 1 the correction factor K was set at 1, and if there were no homozygous individuals the correction factors AAavg and BBavg were set at 1 and 0, respectively.

Step 3) We compared allele frequencies calculated on individual typings and based on the results in the testpool. From this we estimated a fourth degree polynomial where the real results are on the X-axis. See FIG. 1 for a genotyping result in individuals tested separately and in pool with almost 18000 SNPs. Genotyping was done using the 18K Chicken SNP iSelect Infinium assay (Illumina Inc, USA), with SNPs evenly distributed throughout the chicken genome (van As et al., 2007). Details on the assay, workflow and chip can be found on the website of Illumina (http://www.illumina.com/pages.ilmn?ID=12).

From this polynomial we calculated the predicted allele frequency in the testpool when the expected frequency from individuals would be 0, 0.05, 0.1, 0.15 . . . 0.9, 0.95 and 1.

Putting these results in a second graph with the real frequencies on the Y-axis, we obtained correction factors for the third step of correction, see FIG. 2.

After applying these correction factors, the allele frequencies in the testpool showed a linear relation with the real frequencies, see FIG. 3.

In this experiment with about 18.000 SNP's over 96% of the allele frequencies measured in the testpool of 50 individuals (and corrected as described) were within the range of + or −6.25% compared to the results from individual typings.

For application of the invention, the previous 3 steps are preferably performed prior to the actual analysis as a “calibration” in order to enhance accuracy of the analysis. These steps need however not to be performed each time. The calibration of the measurements (if performed) is then to be followed up by:

Step 4) Construct DNA pools of 2, 3 or n individuals in the (ideal) ratio 1:3, 1:3:9 or 1:3¹:3²:3⁽ⁿ⁻¹⁾., and subject the pools to the measurement for genotyping, wherein signal intensities are determined for red and green on a microarray using the 18K Chicken SNP iSelect Infinium assay (vide supra).

Step 5) With the correction factors found in step 1 and step 3 the allele frequencies can be calculated from the resulting signal intensities in the pool. With two individuals in a pool the predicted corrected frequencies give the result points 0%, 12.5%, 25.0%, 37.5%, 50.0%, 62.5%, 75.0%, 87.5% and 100%. Rounding off should be done to the nearest result point. The genotypes of the two individuals can be derived from the results as indicated in Table 2.

With 3 individuals in a pool rounding off should be done to the nearest result point where intervals between result points are 3.85% (100/(3³−1)) etc.

The shorter the intervals between the consecutive result points, the more accurate readings of intensities need to be in order to allow proper allocation of a particular result to one of the result points. More accurate readings will become feasible with further development of the genotyping technique.

TABLE 2
Result points of allele frequencies in pooled samples and inferred
genotypes of the two individuals in the pool for a SNP with A and C allele

| Result point | Inferred genotype | Inferred genotype |
|---|---|---|
| of frequency | of individual 1 | of individual 2 |
| of allele A in | (present in pool in | (present in pool in |
| pooled sample | 1 part) | 3 parts) |
| 0 | CC | CC |
| 12.5 | AC | CC |
| 25 | AA | CC |
| 37.5 | CC | AC |
| 50 | AC | AC |
| 62.5 | AA | AC |
| 75 | CC | AA |
| 87.5 | AC | AA |
| 100 | AA | AA |

SNP's which show a larger difference than 6.25% between pooled results and individual results (in step 3) could be omitted if no other information is available to infer individual genotypes.

Additional information to infer individual genotypes may be derived from the pedigree of the individuals or from information on the haplotypes that are present in the family or the population to which the individual belongs.

Depending on the repeatability of the correction factors, step 1, 2 and 3 may be completely skipped in a new analysis where assay conditions are known to be the same.

When following the method of Example 1, significant savings can be obtained by reducing the total number of samples that need to be analysed whilst still obtaining reliable results on the original individual samples. Typical reductions of the total numbers of samples to be analysed are exemplified in Table 3.

TABLE 3
Savings in the number samples to be analysed when pooling 2 or 3
individuals following the method of the invention.

| | Number of | | | | | | | |
|---|---|---|---|---|---|---|---|---|
| | samples when 2 individuals are pooled | | | | Number of | | | |
| | | | | Reduction | samples when 3 individuals are pooled | | | |
| | | | | of number | | | | Reduction of |
| Number of | | | | of samples | | | | number of |
| individuals | Number of | Number of | Total | to be | Number of | Number of | Total | samples to |
| to be | individuals | pools of 2 | number of | analysed | individuals | pools of 3 | number of | be analysed |
| genotyped | plus pool | individuals | samples | (%) | plus pool | individuals | samples | (%) |
| 250 | 50 + 1 | 100 | 151 | 39.6 | 50 + 1 | 67 | 118 | 52.8 |
| 500 | 50 + 1 | 225 | 276 | 44.8 | 50 + 1 | 150 | 201 | 59.8 |
| 1000 | 50 + 1 | 475 | 526 | 47.4 | 50 + 1 | 317 | 368 | 63.2 |
| 2000 | 50 + 1 | 975 | 1026 | 48.7 | 50 + 1 | 650 | 701 | 64.9 |
| 5000 | 50 + 1 | 2475 | 2526 | 49.5 | 50 + 1 | 1650 | 1701 | 66.0 |

### Example 2

Example of Using the Pooling Procedure for Genotyping of Diploid Individual Samples Using 50 Individual Samples and 25 Pools of 2 of these Individuals for for Finding the Correction Factors.

Step 1) 50 individuals are tested separately as in step 1, example1.

Step 2) Construct 25 pools of 2 samples each in the optimal ratio 1:3 including all 50 individuals from step 1 above. In these pools estimate allele frequencies either uncorrected or based on the correction factors found in the first step.

Step 3) Compare the sum of the allele frequencies from the 2 individual typings and the estimated frequency in the pools of 2 individual samples. From these 25 points calculate a regression line. The regression coefficient and intercept can then be used to correct the estimated frequencies from other pools.

Step 4) Then construct DNA pools of 2, 3 or n individuals in the ratio 1:3, 1:3:9 or 1:3¹:3²:3⁽ⁿ⁻¹⁾.

Step 5) With the correction factors found in step 1 and step 3 calculate the allele frequencies from the resulting signal intensities in the pool.

The savings in sample numbers are about identical to the savings mentioned in Table 8 for sequencing diploid individuals (Only 1 pool of all individuals is not used in this example).

### Example 3

Example of Genotyping of Haploid Individual Samples.

When two haploid samples are pooled and measured for the presence of allele A at a certain position in the genome, the expected ratios in the measurements (peak height, surface under peak, intensities) are as in table 4;

TABLE 4
Result points of allele frequencies in pooled samples with 2 haploid
individuals and inferred genotypes of the two individuals in
the pool for a SNP with A and C allele

| | | Inferred |
|---|---|---|
| | Inferred | genotype of |
| | genotype of | individual 2 |
| Result point of | individual 1 | (present in |
| frequency of allele A | (present in pool | pool in 2 |
| in pooled sample | in 1 part) | parts) |
| 0.00 | C | C |
| 0.33 | A | C |
| 0.67 | C | A |
| 1.00 | A | A |

If only pools of two samples are used correction factors may not be needed. When more samples are pooled correction factors probably are needed. They then can be calculated from pools of 2 samples with equal amounts of the analyte to simulate heterozygous and homozygous diploid individuals.

When pooling 3 samples are pooled in a ratio of 1:2:4, the following ratios in the measurements are expected;

TABLE 5
Result points of allele frequencies in pooled samples with 3 haploid
individuals and inferred genotypes of the three individuals in the pool for a
SNP with A and C allele

| | | Inferred | Inferred |
|---|---|---|---|
| | Inferred | genotype of | genotype of |
| Result point of | genotype of | individual 2 | individual 2 |
| frequency of | individual 1 | (present in | (present in |
| allele A in pooled | (present in | pool in 2 | pool in 4 |
| sample | pool in 1 part) | parts) | parts) |
| 0.000 | C | C | C |
| 0.166 | A | C | C |
| 0.333 | C | A | C |
| 0.500 | C | C | A |
| 0.666 | A | C | A |
| 0.833 | C | A | A |
| 1.000 | A | A | A |

### Example 4

Use of the Invention in Sequencing Protocols

The method of pooling described in this invention can be applied to situations were there is a need to determine sequences in 2 or more fragments of nucleotide sequence such as DNA.

Pooling of DNA fragments, templates or PCR products for sequencing is not common practice because the essential problem when analyzing a double trace is that two bases are represented at each position and it is impossible to tell from which template each base came by exampling only the trace.

In addition to deliberately pooled templates resulting in double traces, several biological and biotechnical situations are known that give rise to double traces. These are seen in alternative spliced regions of a transcript that are amplified by RT-PCR, direct sequenced (without cloning) and random insertional mutagenesis experiments.

Several methods have been described to trace back the haplotypes of pooled sequences or double traces. Flot et al. 2006 describe several molecular methods that have been proposed to find out the haplotypes of an individual. E.g. sequencing cloned PCR products (e.g. Muir et al., 2001), SSCP (single stranded conformation polymorphism) (Sunnucks et al., 2000), denaturating gradient gel electrophoresis (DGGE) (Knapp 2005), extreme DNA dilution to single-molecule level (Ding & Cantor 2003) and the use of allele-specific PCR primers (Pettersson et al., 2003). In addition several computational methods have been purposed for haplotype reconstruction of mixtures of sequences.

All the described methods, however, can be very costly and time-consuming and are only applicable to specific purposes (e.g. resequencing, alternative splicing, templates or PCR amplified mixtures of two products that differ in sequence length, the availability of a reference genome sequence) and not for standard direct sequencing or de novo sequencing of completely unknown sequences.

The pooling of sequence templates following the pooling described in this invention is preferably applied to situations where the same sequence fragment can be obtained from separate individual samples.

In all applications mentioned above, if pooling is applied on purpose, equal amounts of template (samples, DNA, RNA or PCR product) are pooled. Herein we describe the pooling of unequal amounts of template. For this example only the situation for a pool consisting of 2 templates is described, but the invention can be used to construct pools of DNA (or RNA or post-PCR products) of 2, 3, or n individual samples in the ratio of 1:2, 1:2:4, 1:2¹:2²:2⁽ⁿ⁻¹⁾.

General conditions that need to be met are that the sequencing device scans templates (e.g. for fluorescence) and the resulting chromatogram represents the sequence of the DNA template as a string of peaks that are regularly spaced and of similar height.

Step 1) Perform Sequence Reactions for 50 Individual Samples Separately

The data on the individual sequencing reactions are used to calculate the correction factors from the peak areas or peak heights for all base (or nucleotide) positions.

Step 2) Perform Sequence Reactions for 25 Pools of 2 Pooled Individual Samples

Peak area ratios are used to discriminate between first and second peak at base and noise peaks. The second peak is a percentage of the first peak and a threshold value is used to discriminate between peaks and noise peaks. The data on the pooled sequencing reactions are used to calculate the correction factors from the peak areas or peak heights for all base (or nucleotide) positions.

Step 3) Make a Graph of the Results of Step 1 and 2 and Construct the Regression Line (Calculate Regression Coefficient and Intercept).

Step 4) Construct Pools of DNA (or Post-PCR Products)

Pools are constructed of 2, 3, or n individual samples in an optimal ratio of of 1:2, 1:2:4, 1:2¹:2²:2⁽ⁿ⁻¹⁾.

Step 5) With the Correction Factors Found in Step 1, 2 and Step 3, the Base Calling can be Calculated from the Resulting Signal Intensities in the Pool

In this example only 2 potential nucleotides (A and C) at each base position, are shown but the same principle works for other combinations of 2 out of the 4 available nucleotides that are basis of the genetic code. The average peak height for the “A” nucleotide is set to 100 and the average peak height of the “C” nucleotide is 75. Based on these peak heights, for every possible combination of nucleotides in the pool of two samples the relative peak heights are presented in Table 6. Table 7 similarly presents peak heights for nucleotide G and T.

TABLE 6
Result points of nucleotides (A and C) or nucleotide combinations in
pooled and unpooled single stranded DNA fragments and inferred nucleotide
for a random position in the nucleotide sequence.

| | | Peak area/height | | Peak area/height | |
|---|---|---|---|---|---|
| Inferred nucleotide | | Unpooled | | Pooled (1:2 ratio) | |
| Individual | Individual | First | Second | First | Second |
| sample 1 | sample 2 | peak (A) | peak (C) | peak (A) | peak (C) |
| A | | 100 | | | |
| C | | | 75 | | |
| A | A | | | 100 | |
| A | C | | | 33.3 | 50 |
| C | A | | | 66.6 | 25 |
| C | C | | | | 75 |

TABLE 7
Result points of nucleotides (G and T) or nucleotide combinations in
pooled and unpooled single stranded DNA fragments and inferred
nucleotide for a random position in the nucleotide sequence.

| | | Peak area/height | | Peak area/height | |
|---|---|---|---|---|---|
| Inferred nucleotide | | Unpooled | | Pooled (1:2 ratio) | |
| Individual | Individual | First | Second | First | Second |
| sample 1 | sample 2 | peak (G) | peak (T) | peak (G) | peak (T) |
| G | | 90 | | | |
| T | | | 120 | | |
| G | G | | | 90 | |
| G | T | | | 30 | 80 |
| T | G | | | 60 | 40 |
| T | T | | | | 120 |

TABLE 8
Savings in the number of samples or sequence reactions when pooling
2 individual samples following the method of the invention.

| | Number of pools or samples to be | | | |
|---|---|---|---|---|
| | sequenced using this invention | | | |
| Number of | | | Total | |
| individual | Individual | Pools of 2 | number | Reduction of number |
| samples to be | samples + | individual | of | of samples to be |
| sequenced | pools | samples | samples | sequenced (%) |
| 250 | 50 + 25 | 100 | 175 | 30% |
| 500 | 50 + 25 | 225 | 300 | 40% |
| 1000 | 50 + 25 | 475 | 550 | 45% |
| 2000 | 50 + 25 | 975 | 1050 | 47.5% |
| 5000 | 50 + 25 | 2475 | 2250 | 49% |

### Example 5

Example of Genotyping of Diploid Individual Samples Using 1 Pool of 50 Individuals and 25 Pools of 2 Individuals for Finding Correction Factors and Using Alternative Correction Methods. The Example Describes Several Experiments.

Step 1) 50 individuals were tested separately.
Same as in Example 1, Step 1 but with different correction method(s) using normalised intensities X and Y in stead of Xraw and Yraw.

The first correction factor (K) is calculated using X and Y.

K=avg (X/Y)

where X is the normalized intensity for the A allele (red) and Y is the normalized intensity for the B allele (green). This value was determined from the individually genotyped samples with genotype AB.

The other correction factors AAavg and BBavg are also based on X and Y. AAavg is the average of the uncorrected A-allele frequencies of AA genotypes. This value is expected to be close to 1. BBavg is the average of the uncorrected A-allele frequencies of BB genotypes. This value is expected to be close to 0.

AAavg and BBavg were calculated using the formulas:

AAavg=(avg(X/(X+Y)))

and

BBavg=(avg(X/(X+Y)))

All correction factors K, AAavg and BBavg can also be calculated based on Xraw and Yraw as in Example 1, Step 1.

If no genotypes AA are available among the 50 individuals AAavg is set to 1. Also if no BB genotypes are available then BBavg is set to 0.

Next step is to calculate allele frequencies based on the individual typings for those SNPs where all 50 individuals had a result.

Step 2) One pool was constructed including all 50 individuals from step 1 as in Example 1, Step 2.

Uncorrected allele frequency for allele A is calculated as a ratio between normalized red intensity (X) divided by the sum of both normalized intensities (X+Y)

Uncorrected allele frequency=X/(X+Y) (called Raf)

The first correction for allele frequency we applied is

Corrected allele frequency=X/(X+K*Y) (called Rafk)

If there were no heterozygous genotypes, K can not be calculated. In that case following rules can be applied;

If Raf<0.1 then Rafk is set to 0.

If Raf>0.9 then Rafk is set to 1.

In all other situations were K is missing Rafk is set equal to Raf.

An other approach is to set K=1 if K can not be calculated from heterozygous genotypes.

The normalisation correction using AAavg and BBavg is not always needed when you start with the normalised intensities X and Y. If you start with Xraw and Yraw normalisation using AAavg and BBavg can be applied as in Example 1, Step 2.

If normalisation is applied then use the following formula;

Normalized allele frequency=(Corrected allele frequency−BBavg)/AAavg (called Rafn)

Step 3) We compared the expected allele frequencies calculated on individual typings in step 1 and the observed (corrected or uncorrected) frequencies based on the results in the pool of 50 in Step 2. From this we calculated the regression coefficients using following model;

Expected allele frequency=b1*observed frequency+b2* observed frequency²+b3*observed frequency³+b4*observed frequency⁴ without intercept.

Either the corrected (Rafk and Rafn) or uncorrected frequencies (Raf) are used as observed frequency in the formula above.

By comparing the expected with the predicted allele frequency from the model the best correction procedure (Rafk, Rafn or Raf) can be found.

The regression coefficients from the best correction procedure can later be used to correct the allele frequencies from the pools of 2 individuals in Step 5a.

Step 4) From the 50 individual samples construct 25 DNA pools of 2 individuals in the ratio 1:3. Note which individual is used once and which one is used 3 times in the pool

Step 5a) Correction based on results of pool of 50 individuals.

With the correction factors found in Step 1 (K, AAavg and BBavg) and Step 3 (regression factors b1, b2, b3 and b4) the allele frequencies can be calculated from the resulting signal intensities in the pools, constructed under Step 4.

First Raf or Rafk or Rafn is calculated (depending on the best correction procedure found in Step 3) using correction factors K, AAavg and BBavg from Step 1.

Then Rafc or Rafkc or Rafnc is calculated using the polynomial regression coefficients found under Step 3 as

Expected allele frequency=b1*observed frequency+b2* observed frequency²+b3*observed frequency³+b4*observed frequency⁴ where observed frequency=Raf or Rafk or Rafn.

With two individuals in a pool the predicted corrected frequencies should give the result points 0%, 12.5%, 25.0%, 37.5%, 50.0%, 62.5%, 75.0%, 87.5% and 100%. Rounding off should be done to the nearest result point. The genotypes of the two individuals can be derived from the results as indicated in Table 2 of Example 1.

Step 5b) Correction based on results of pools of 2 individuals.

Raf, Rafk and Rafn are calculated based on the signal intensities of the pools constructed under Step 4 and the correction factors K, AAavg and BBavg found under Step 1.

Then polynomial regression coefficients using the same model as in Step 3, Example 5 can be calculated based on 20 pools. This model can be applied on every SNP separately or across all SNPs.

The allele frequencies in the other 5 pools are predicted based on these regression factors as:

Rafkc=b1*Rafk+b2*Rafk²+b3*Rafk³+b4*Rafk⁴ from regression model with Rafk.

Rafn=b1*Rafn+b2*Rafn²+b3*Rafn³+b4*Rafn⁴ from regression model with Rafn

Rafc=b1*Raf+b2*Raf²+b3*Raf³+b4*Raf⁴ from regression model with Raf.

This can be repeated 5 times in such a way that all samples are used for prediction once. The expected allele frequencies in these pools then are compared with the predicted allele frequencies to find the best correction procedure.

With two individuals in a pool the predicted corrected frequencies should give the result points 0%, 12.5%, 25.0%, 37.5%, 50.0%, 62.5%, 75.0%, 87.5% and 100%. Rounding off should be done to the nearest result point. The genotypes of the two individuals can be derived from the results as indicated in Table 2 of Example 1.

Step 5c) Correction based on results of pools of 2 individuals. Another way of prediction can be done using multi linear regression coefficients by SNP on the light intensities (X or Xraw and Y and Yraw) based on the following model

Expected allele frequency=intercept+b1*X+b2*Y

or

Expected allele frequency=intercept+b1*Xraw+b2*Yraw.

With these multi linear regression factors (intercept, b1 and b2) allele frequencies for other pools can then be predicted using

Predicted allele frequency=intercept+b1*X+b2*Y

or

Predicted allele frequency=intercept+b1*Xraw+b2*Yraw

The multi linear regression coefficients, as describe above, are calculated based on 20 pools.

Then the allele frequencies of the other 5 pools are predicted based on these regression factors. This is repeated 5 times in such a way that all samples are used for prediction once. The expected allele frequencies in these pools then can be compared with the predicted allele frequencies to find the best correction procedure.

As in Step 5a and Step 5b the genotypes of the two individuals can be derived from the results as indicated in Table 2 of Example 1.

Step 6) From other individual samples construct DNA pools of 2 individuals in the ratio 1:3. Note which individual is used once and which one is used 3 times in the pool as in Step 4.

From these pools we can get the genotypes using the best correction method for prediction of the allele frequency as described and using Table 2 of Example 1.

—Experiment 1

Application of Procedures Described in Example 5 to Whole-Genome SNP Analysis using Infinium Assay BeadChip technology (Illumina, Inc. USA).

Genotyping was done on 50 individuals using the 18K Chicken SNP iSelect Infinium assay (Illumina Inc, USA), with SNPs evenly distributed throughout the chicken genome (van As et al., 2007). Details on the assay, workflow and chip can be found on the website of Illumina (http://www.illumina.com/pages.ilmn?ID=12).

To check whether frequencies can be estimated accurately, 8 alleles (from 4 different animals out of the 50 individually genotyped individuals) were combined in one pool. Steps 1 to 3 and Step 5, as describe in Example 5, were taken except the translation from predicted allele frequencies into genotypes, using Table 2, was not performed.

In Step 4 equimolar quantities of DNA of 4 individuals were pooled in stead of DNA from 2 individuals in the ratio 1:3.

If ratio 1:3 from 2 different animals is used we can regard this is combining 8 alleles into a pool. By using equimolar quantities of 4 individuals also 8 alleles are combined.

This way 12 pools were composed and one pool of 50 animals as in step 1 (same samples are used as in the pools of 4 plus the 2 extra samples). Then these 13 pools were genotyped using a second batch of infinium chips.

K, AAavg and BBavg per SNP were calculated as in Example 5, Step 1. Then uncorrected and corrected allele frequencies from the pool of 50 were calculated as in Example 5, Step 2.

Also polynomial regression coefficients were calculated as in Example 5, Step 3.

Further more the polynomial and multi linear regression coefficients, as described in Step 5b and 5c, were calculated. This was done based on 11 pools and then allele frequencies in the remaining pool was predicted using the regression factors. This is then repeated 12 times such that every pool was used once for prediction.

In this experiment the multi linear regression on X and Y (intensities for red and green) gave the best results. For final results see FIG. 4 and Table 9.

In total 4.6% of the allele frequencies were falling in the wrong class. In case these were pools of 2 individuals in a ratio of 1:3 this would have resulted in 3.0% genotyping errors.

TABLE 9
Number of predicted allele frequencies by class compared to the
expected allele frequencies. The numbers on the diagonal will lead to correct
genotypes. The allele frequencies outside the diagonal but within the boxes
will result in one genotype error. The other results will end in 2 genotype
errors.

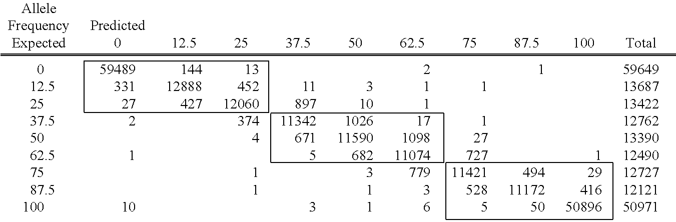

Error detection programs can further reduce the number of mismatches using information from a reference set of haplotypes, allele frequencies, linkage disequilibrium and pedigree.

—Experiment 2

Application of Procedures Described in Example 5 to SNP Analysis using Veracode Assay technology (Illumina, Inc. USA).

Genotyping was done on 50 individuals using the 96 Chicken SNP Veracode, Golden Gate Assay (Illumina Inc, USA), with SNPs evenly distributed throughout the chicken genome (Step 1). Details on the assay, workflow and chip can be found on the website of Illumina (http://www.illumina.com/pages.ilmn?ID=6)

Also 1 pool of all samples was constructed (as in Step 2) and 24 pools of 2 individuals in the ratio 1:3 (as in Step 4). These 25 pools were genotyped with a second batch of chemicals.

All corrections were done as described in Step 1 to 3 of Example 5.

The correction in Step 5a was applied on all 24 pools of 2 using the polynomial regression factors found in Step 3.

For Step 5b and Step 5c we used 23 pools every time to calculate the regression factors (polynomial in Step 5b and multi linear in Step 5c) to be able to predict the allele frequencies for the remaining pool. In total we did this 24 times so all pools were used once to predict the allele frequencies.

The best results were obtained using Rafk (calculated on base of normalised values X and Y) and then corrected using the polynomial regression factors from Step 5b resulting in Rafkc.

In total 84 SNPs were called in the individuals. Then some SNPs were not called on some of the individuals. In total we had 1906 complete combinations of pool*SNP.

TABLE 10
Number of predicted allele frequencies by class compared to the
expected allele frequencies. The numbers on the diagonal will lead to correct
genotypes. The allele frequencies outside the diagonal but within the boxes
will result in one genotype error. The other results will end in 2 genotype
errors.

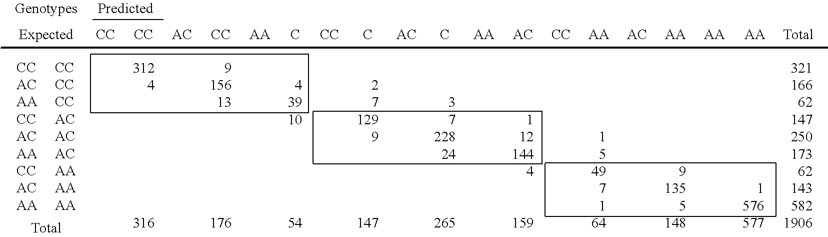

In total there were 138 (138/1906*100=7.2%) mismatches (Table 10). Because every observation consists of 2 individual samples this resulted in 174 genotype errors (170/1906*2*100=4.46%), see Table 11, FIG. 5 and FIG. 6.

The process of defining the best correction procedure in this example (as done using Step 3 (Example 5) and Step 5a, 5b or 5c (Example 5)) also delivers information about the number of mismatches by SNP. This makes it possible to eliminate a SNP from the set to reduce the risk of mistakes at an expense of lower call rates.

Error detection programs can further reduce the number of mismatches using information from a reference set of haplotypes, allele frequencies, linkage disequilibrium and pedigree.

TABLE 11
Number of correctly predicted genotypes

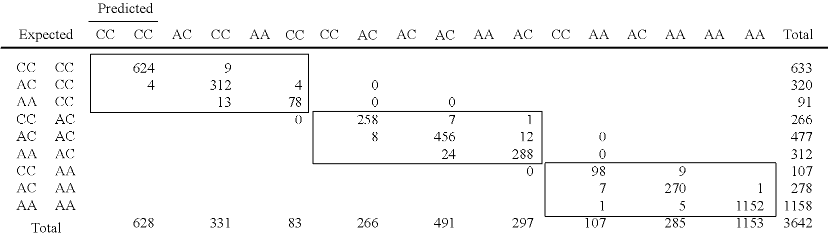

—Experiment 3

Application of procedures described in Example 5 to SNP analysis using other genotyping methods.

The procedures described in Example 5 can also be used in any other genotyping method, other than the methods described in Experiment 1 and Experiment 2, such as Affymetrix GeneChip (Affymetrix Inc, USA) or Agilent Technologies.

### Example 6

Use of the Invention in Sequencing Protocols as in Example 4 but Using Other Correction Methods

Step 1) Perform sequence reactions for 50 individuals separately

Use peak height of allele 1 and peak height of allele 2 as the Xraw and Yraw value or the relative peak height as X and Y.

Relative peak height for allele 1 is X=X/(X+Y) and relative peak height for allele 2 is Y=Y(X+Y).

Then calculate K, AAavg and BBavg the same way as done for genotyping in Step 1 of Example 5;

Step 2) Perform sequence reactions in one pool of all 50 individuals Calculated uncorrected and corrected allele frequencies as in Step 2 of Example 5;

Step 3) Calculate frequencies from individual sequencing and from the pool Use same model as in Step 3 of Example 5 to find polynomial regression coefficients.

Step 4) Perform sequence reactions for 25 pools of 2 pooled individuals

Step 5a) Compare corrected frequencies with expected frequencies based on the pool of all 50 individuals to find best method.

Step 5b) Calculate Rafnc, Rafkc and Rafc in 5 pools of 2 individuals using the polynomial regression factors found in the other 20 pools using the model

Expected allele frequency=b1*observed frequency+b2* observed frequency²+b3*observed frequency³+b4*observed frequency⁴ without intercept.

Step 5c) Calculate predicted allele frequency in 5 pools of 2 individuals using the multi linear regression coefficients found in the other 20 pools using the model

Predicted allele frequency=intercept+b1*X+b2*Y

or

Predicted allele frequency=intercept+b1*Xraw+b2*Yraw

From Step 3 and Step 5 determine the best correction procedure by repeating Step 5b and 5c several times in such a way that all pools are being used for prediction of allele frequencies (validation).

If needed other numbers for validation can be used. E.g. one can use 24 pools for finding the regression factors and then predicting one using these factors. In total one then needs to repeat this 25 times.

With the best correction procedure and the needed correction factors and regression factors it was possible to predict frequencies of new pools and read the resulting alleles in Table 2.

### Example 7

The present example shows one way of determining the actual ratio by which the analyte (e.g. DNA) of the individuals contributing to the pool has been pooled.

Method

Given that 2 individuals were pooled in proportions π and (1-π) and allele frequencies for biallelic loci were obtained. The expected allele frequency is found from the following table (table 12) given the genotypes of the 2 individuals.

TABLE 12
Expected allele frequencies (Ei) in the pool given the mixing
proportion (π) and the genotypes of the 2 individuals.

| | | π Individual 1 | | |
|---|---|---|---|---|
| Locus A | | aa | Aa | AA |
| 1 − π | aa | 0 | π/2 | π |
| Individual 2 | Aa | (1 − π)/2 | .5 | (1 + π)/2 |
| | AA | 1− π1 | 1 − π/2 | 1 |

The mixing proportion will be common to all loci for the pool of interest.

The method. Find the average allele frequency over all loci, call this Q. Then start with a guessed value of π and determine the probability the observed allele frequency for the i* locus (pi) was sampled from each of the given cells. Assume there are n beads used to estimate pi=nA/n, then nA=npi (nA=number of occurrences that allele A is present). I use for value n something in the range of 20 to 30. You can also think of this as the reliability of the estimate, the higher n, the more reliable. Next compute the probability the observation came from a given cell.

P(observation was sampled from cell|pi and π)=

P(Eᵢ|pᵢ, π)=e⁻⁽ⁿ₀-nE

[symbol]

This is an approximate probability, assuming a normal distribution with the probability decreasing as the observed and expected values become far apart.

The cell with the maximum probability is chosen and the putative allele frequencies for each individual are taken from the row and column genotypes associated with that cell.

This process is repeated for all loci, using the same n for all loci.

Next the average allele frequency based on the putative genotypes across all loci for each individual is computed. Call these s1 and s2. If the mixing proportion is correct then the expectation is that

Q=πs₁+(1−π)s₁

If not, then the value of n should be updated for use in the next iteration. This updated value of π (phi) is solved as:

Phi=(Q−s₂)/(s₁−s₂).

Finally, if this procedure is completed on an entire line, the expected value of s1 and s2 is the average across the line. Let E(s1)=S1 and E(s2)=S2. If the pools are taken from one line, then S1=S2. In either case, knowledge of the expected values can be incorporated into the Expectation Maximization (EM) assuming random mating within a line. The probability of belonging to a cell is changed to include the probability of sampling that pair of genotypes.

TABLE 13
Probability of sampling a given pair of genotypes.

| | | Individual 1 | | |
|---|---|---|---|---|
| Locus A | | aa (1 − S1)² | Aa 2S1(1 − S1) | AA S1² |
| Individual 2 | aa (1 − S2)² | (1− S2)²(1 − S1)² | 2S1(1 − S1) (1- S2)² | S1²(1 − S2)² |
| | Aa 2S2(1 − S2) | 2S2(1− S2) (1 − | 2S2(1 − S2)2S1(1 − | 2S2(1 − S2)S1² |
| | AA S2² | S2² (1 − S1)² | S2²2S1(1 − S1) | S2²S1² |

This is the unconditional probability of sampling the pair of genotypes.

This is multiplied times the probability of the genotypes given the observed frequency, i.e. Table 12.

The combined probability is used to assign observations to cells. The value of S1 and S2 will update with each round. If these values are known from prior estimates, then they do not update, but are set as constants.

Maximization parameters can be used to delete results from certain pools exceeding accepted levels for this parameter.

### Example 8

The present example shows another way of determining the actual ratio by which the analyte (e.g. DNA) of the individuals contributing to the pool has been pooled. This approach may be used as an alternative to the methods given in Example 7 and Example 9 or in addition to one, or all of said methods if individuals contributing to the pool are coming from different populations where some SNP markers are fixed for the opposite alleles.

If average allele frequencies of the populations are known from individual typings or population pools, there might be markers which are completely fixed for the opposite alleles. E.g. population 1 is carrying only allele A and population 2 is carrying only allele C for a certain SNP marker. Suppose then that 1 individual from population 1 is pooled with an individual from population 2 in ratio 1:3. The signal for allele A in a pooled sample is expected to be 2/8=0.25 (1*2=2 times allele A and 1*0=0 times allele C from individual 1 and 3*0=0 times allele A and 3*2=6 times allele C from individual 2).

So expected signal=(1/(3+1)* expected signal A for individual 1 plus 3/(3+1)* expected signal A for individual 2)=0.25*1+0.75*0 =0.25.

This is because from individual 2 no signal for A is expected as whole population is fixed for allele C. If observed signal=0.20 then pooling ratio is equal to 0.20/0.20:(1−0.20)/0.20=1:4.

You can get a good estimate for the realized ratio when more markers are fixed for the opposite alleles. Average ratio for all these makers is the best predictor. This realized ratio can be used to get threshold values and their ranges.

### Example 9

The present example shows another way of determining the actual ratio by which the analyte (e.g. DNA) of the individuals contributing to the pool has been pooled. This approach may be used as an alternative to the method given in Example 7 or in addition to the said method.

In this example an iterative procedure could be used. Also neural networks, genetic algorithms, EM, or other algorithms could possibly be used. Iterative procedures could e.g. be programmed in Excel.

### EXAMPLE

Start iterative procedure with ratio=1:3 (pooling factor=3).

When pooling 2 samples one threshold value is 0.625. Range would be 0.5625 and 0.6875. Suppose the signal for marker X is 0.681. Then genotypes would be AA and AB.

Given these genotypes and a pooling factor of 3 you find the expected threshold as

(1*1+pooling factor*0.5)/(pooling factor+1)=(1*1+3*0.5)/(3+1)=2.5/4=0.625.

Now the signal=0.681, the pooling factor can be calculated as

(1*1+pooling factor*0.5)/(pooling factor+1)=0.681 or 1+0.5*pooling factor=0.681*pooling factor+0.681

or 1−0.681=(0.681−0.5)*pooling factor=0.319=0.181*pooling factor. Thus pooling factor=0.319/0.181=1.76

This way a ratio (or pooling factor) for every marker can be found. The new ratio for the second run then is the average of n ratios if n is the number of markers tested. Again thresholds need to be calculated and their ranges. Minimum for this range is the midpoint between this threshold and previous threshold (or 0 if this threshold is the first one) and the maximum for this range is the midpoint between this threshold and the next threshold (or 1 if this threshold is the last one).

Genotypes are reconstructed for sample 1 and sample 2 given the new thresholds. In most cases genotype will not change and then the new calculated ratio for this marker does not change. However for some markers the genotype might change and that will result in a different average ratio.

Again thresholds can be calculated with their ranges.

This can be done until there is no change anymore in ratio from one round to the next.

Convergence is then reached.

### Example 10

The present example shows 2 ways of using population characteristics to increase the probability of assigning the correct genotypes to the individuals contributing to the pool.

In case of markers and with the availability of individual typed samples (or results from population pools) we can calculate the following;
1) Allele frequency (p)=frequency of first allele.
2) LD=linkage disequilibrium. Linkage disequilibrium describes a situation in which some combinations of alleles or genetic markers occur more or less frequently in a population than would be expected from a random formation of haplotypes from alleles based on their frequencies (simple−variation in genotypes for marker 1 is (partly) explained by variation in genotypes for marker 2). LD can be calculated using programs like Haploview on individual genotypings.
Barret J C., et al., (2005). Bioinformatics, January 15 [Pubmed ID:15297300].

Regarding 1.

When nothing is known on genotype for marker X you can randomly assign a genotype (based on allele frequencies) as AA, AB and BB with chances p², 2*p*(1−p) and (1−p)² to be correct.

### EXAMPLE

Pooling ratio=2. This is a special case for genotyping because 1*BB+2*AA are expected to give same signal as 1*AA and 2*AB.

When frequency for A allele=0.8 then chance to have

BB+AA would be 0.2*0.2*0.8*0.8=0.026 and for

AA+AB this would be 0.8*0.8*0.8*0.2=0102

In this case the probability for genotypes AA an AB are 4 times higher as the probability the two individuals have genotype BB and AA.

Regarding 2.

If the genotype of a marker can be reconstructed correctly form the signal, LD between this marker and another can be used to tell more about the genotype of the other marker.

### EXAMPLE

Signal would give 87.5% allele A. According to table 2, page 31 of this document, this would tell you that the first individual has genotype AC and the second one (3 times in the pool) would have genotype AA.

Suppose correlation with other marker=0.90 (LD=R²=0.81). This tells you 81% of variation of genotype for marker 2 is explained by differences in genotype for marker 1.

E.g. allele A of marker 1 if very often going together with allele C of marker 2 and allele C of marker 1 is going together with allele G of marker 2 as in table 14 below. So haplotypes are;

48% AC, 2% CC, 2% AG and 48% CG.

TABLE 14
Allele frequencies for marker 1 and marker 2.

| | Marker 1 allele = A | Marker 1 allele = C |
|---|---|---|
| Marker 2 allele = C | 0.48 | 0.02 |
| Marker 2 allele = G | 0.02 | 0.48 |

When genotype for marker 1 and individual 1 is AC one expect genotype for marker 2 to be CG and when genotype marker 1 for individual 2 is AA one expect genotype for marker 2 to be CC.

So LD can be used to get more information then signal alone.

There are programs on the internet which can be used for detection of genotype errors, given the results of the reconstructed genotype of an individual in a pool and a reference population from individually genotyped samples. These programs in general use information on allele frequencies in the population,LD and pedigree.

### Example 11

The present example shows a way of determining the sensitivity of the actual ratio by which the analyte (e.g. DNA) of the individuals contributing to the pool has been pooled.

To test the feasibility of pooling in various ratios you might set up a series of samples varying in pooling ratio from 1:1 (or lower) up to 1:5 (or higher) in increments of 0.1 (or different).

This need to be repeated for several pools (2 or higher) constructed from samples with known individual results.

Based on the individual results and based on the pooling ratio applied one can calculate the expected signal intensity. By comparing expected and observed signal intensity for all samples one can;

1) Calculate the realized pooling ratio by using expected and realized signal intensity.

2) Calculate standard error of signal intensity for a given pool ratio.

3) Calculate average deviation from expected signal intensity.

4) Calculate standard deviation of difference between observed and expected signal intensity.

5) Calculate accuracy of prediction for both samples in the pool.

6) Calculate the frequency of signals which falls within the expected threshold and plus and minus 6.25 (for pools of 2 samples) and

the expected threshold and plus and minus 1.92 (for pools of 3 samples) (or even smaller ranges for testing the possibility for pooling 4 or more samples).

Based on the accuracy of prediction (5) one chooses the best pooling ratio.

Based on the frequency of signals falling within the threshold and deviation thereof (6) one can decide to pool 2, 3 or more samples.

In case of genotyping individuals from different populations in one pool, one might use information of fixation of opposite alleles in the two populations to calculate the realized pooling ratio (as in example 8).

So when samples of different populations are available for pooling, this will give an advantage in case some of the markers are fixed in for the opposite alleles. These markers can then be used to calculate the pooling ratio from the observed and expected signals for those snp markers.

Results of such an experiment can be found in FIG. 8 for the two individuals contributing to the pool separately.

Remark. Determination of optimal pooling ratio and number of samples in a pool can be done based on calculations done before or after applying error detection and correction if more is known about the populations where individuals belong to.

If information on pedigree, allele frequencies and LD (linkage disequilibrium) and/or reference haplotypes is available one can use these to run error correction programs.

Extra information will help to get better results. How much gain in accuracy can be achieved depends on distribution of allele frequencies, LD in the population(s) and optimal use of error detection programs (also use LD, reference haplotypes, pedigree etc.).

Results of the same experiment but now after error detection and correction can be found in FIG. 9 for the two individuals contributing to the pool separately.

### Example 12

Genotyping was done on 75 individuals using the 96 Chicken SNP Veracode, Golden Gate Assay (Illumina Inc, USA), with SNPs evenly distributed throughout the chicken genome. Details on the assay, workflow and chip can be found on the website of Illumina (http://www.illumma.com/pages.ilmn?ID=6). In total 84 SNPs were called.

Also 25 pools of 3 individuals were constructed in the ratio 1:3:9.

All corrections were done as described in experiment 2.

With three individuals in a pool the predicted corrected frequencies should give the result points 0%, 3.85%, 7.7%, 11.55%, . . . , 96.15% and 100% (or n*3.85% where n=0 to 26). Rounding off should be done to the nearest result point. Maximum error of signal value in this case is also 3.85/2=1.925%. (With 2 samples in a pool this was 12.5/2=6.25%). So signal for the categorical measurement point should be much more accurate. In case of 3 samples in a pool we found that for the best correction method 53% of the signals (pool* markers=25*84) did not fall within the expected range. Expected range can be calculated on the base of the individual genotypings and there presence in the pool (1, 3 or 9 times).

### LEGENDS TO THE FIGURES

FIG. 1 shows in a graphical display the correlation between the allele frequency as based on pooled data (Y-axis) and the allele frequency as based on individual measurements (X-axis).

FIG. 2 shows in graphical display the relationship between allele frequency as measured on individuals (Y-axis) and the predicted allele frequencies in pool (X-axis).

FIG. 3 shows in graphical display the relationship between the corrected allele frequency in the pool (Y-axis) and the allele frequencies measure on individuals after individual typing (X-axis).

FIG. 4 shows in graphical display the difference between the expected (based on individual typings) and predicted allele frequencies for pool 1 in experiment 1.

FIG. 5 shows in graphical display the correlation between the expected (based on individual typings) and predicted allele frequencies for all pools in experiment 2.

FIG. 6 shows in graphical display the difference between the expected (based on individual typings) and predicted allele frequency for all pools in experiment 2.

FIG. 7 show graphical representation of one embodiment of the invention.

FIG. 8. Relation between actual pooling ratio (based on expected signals for markers fixed in opposite direction for the 2 individuals in the pool) and accuracy in genotyping Pools with Chicken DNA before error detection.

FIG. 9. Relation between actual pooling ratio (based on expected signals for markers fixed in opposite direction for the 2 individuals in the pool) and accuracy in genotyping Pools with Chicken DNA after error detection.

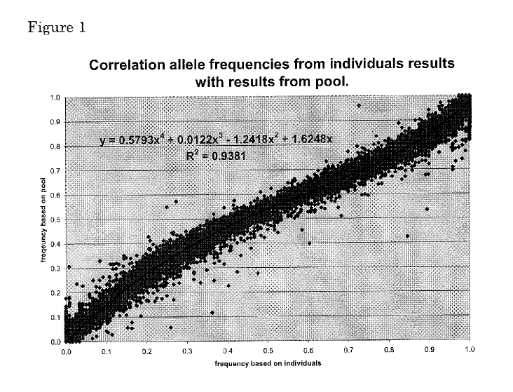

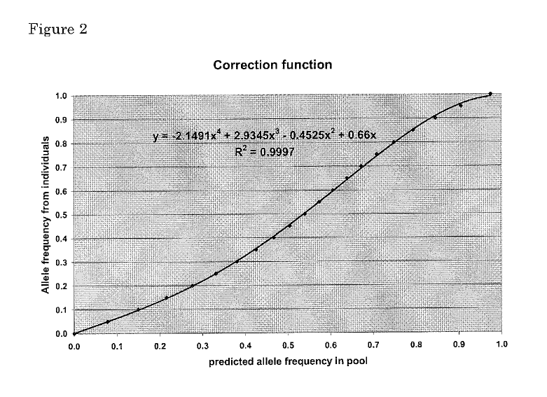

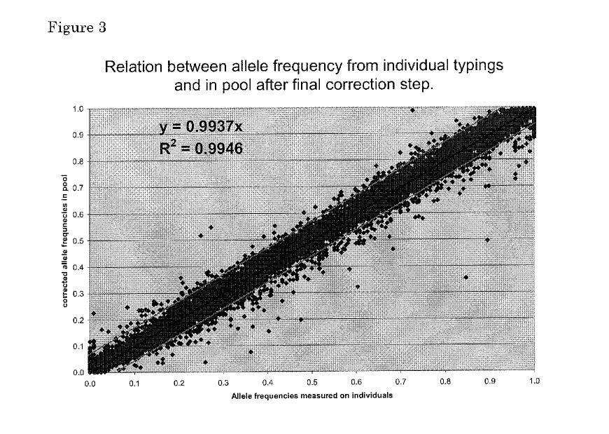

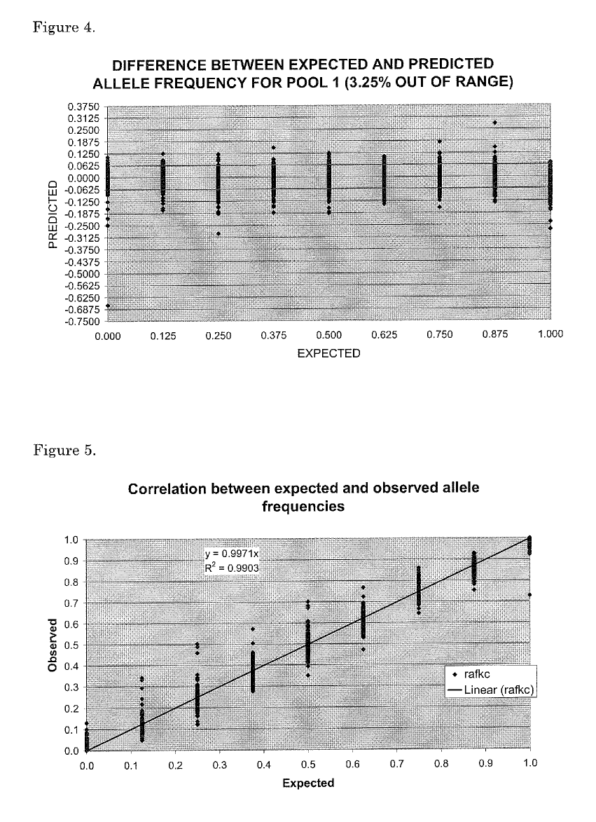

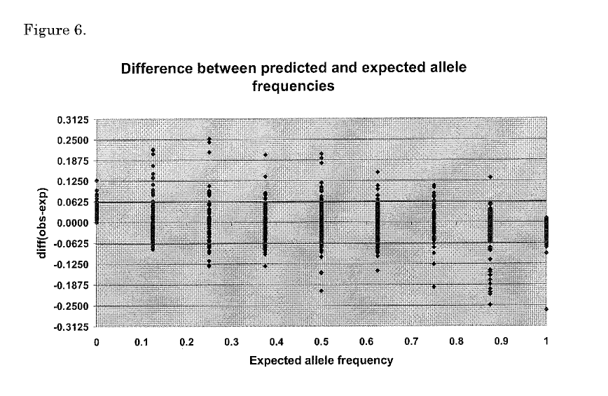

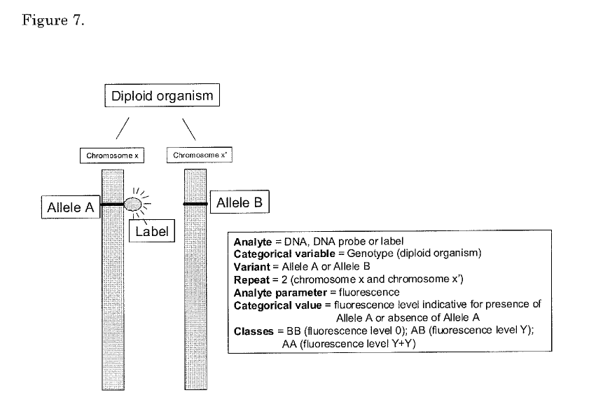

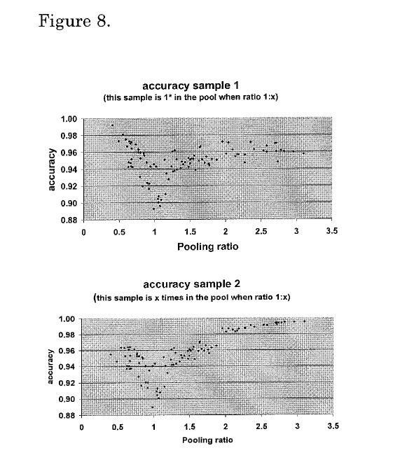

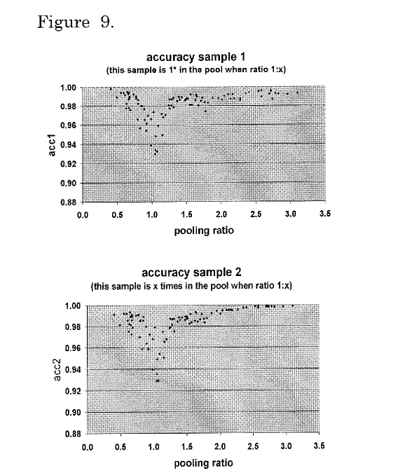

1. A method for typing nucleic acid at a first position in the nucleic acid of at least two sources in an assay,
said method comprising providing from each of said at least two sources an individual sample comprising nucleic acid of said source
and
pooling said individual samples such that the ratio of amounts of nucleic acid of said at least two sources in the pool allows for the assay to discriminate between the frequencies of each potential variant at said position in said assay,
said method further comprising
measuring the frequency of at least one of said potential variants in said pooled sample
and;
determining from said measured frequency, the nucleic acid type at said first position in the nucleic acid of said at least two sources.

2. A method according to claim 1, wherein said at least two sources are at least two organisms.

3. A method according to claim 2, wherein said at least two organisms are of the same species.

4. A method according to any one of claims 1-3, wherein said nucleic acid comprises DNA.

5. A method according to any one of claims 2-4, wherein said at least two organisms are cellular organisms.

6. A method according to claim 4, wherein nucleic acid at said first position is typed in the nucleic acid of cells of said at least two organisms.

7. A method according to claim 6, wherein at least one of said individual samples contains nucleic acid of only one individual organism.

8. A method according to claim 7, wherein essentially all individual samples contain nucleic acid of only one individual organism and wherein essentially all of said individual organisms are from different organism specimens.

9. A method according to any one of claims 1-8, wherein said assay comprises a reference in which the frequency of at least one of said variants at said first position is known.

10. A method according to any one of claims 1-9, wherein essentially all frequencies are above the detection limit of the assay.

11. A method according to any one claims 1-10, further comprising determining a difference between the measured frequency of at least one of said variants at said position and the frequency thereof expected as a result of the pooling of said individual samples.

12. A method according to claim 11, further comprising determining from said difference the actual ratio's of amounts of nucleic acid of at least two of said at least two organisms in the pool.

13. A method according to any one of claims 1-12, wherein said pooled sample is obtained by pooling cells of said at least two organisms.

14. A method according to any one of claims 1-13, further comprising measuring the frequency of at least a second of said potential variants in said pooled sample
and;
determining from said the measured frequencies of said at least two variants, the nucleic acid type at said first position for said at least two organisms.

15. A method according to claim 14, wherein determining the nucleic acid type at said first position comprises determining the ratio of said first and said second measured frequency.

16. A method according to any one of claims 1-15, wherein said position contains 1 nucleotide and said typing of DNA comprises determining the nucleotide(s) at said position.

17. A method according to any one of claims 1-16, further comprising typing nucleic acid at a second position in the nucleic acid of said at least two organisms.

18. A method according to claim 17, comprising measuring the frequency of at least one potential variant at said second position in said pooled sample and determining there from the nucleic acid type at said second position in the nucleic acid of said at least two organisms.

19. A method according to claim 17 or claim 18, wherein the nucleic acid type at said second position in the nucleic acid is determined on the basis of the actual ratio's of the amounts of nucleic acid of said at least two organisms in the pool.

20. A method according to any one of claims 17-19, wherein said second position is adjacent to said first position.

21. A method according to claim 20, further comprising determining the nucleic acid type at further consecutive positions in the nucleic acid of said at least two organisms thereby sequencing nucleic acid of said at least two organisms.

22. A method according to any one of claims 1-21, wherein said individual samples comprise chromosomal DNA.

23. A method according to any one of claims 1-22, wherein said first position occurs two or more times in said organism, for instance on homologous chromosomes.

24. A method according to claim 23, wherein the nucleic acid type at said first position is determined for each occurrence of said first position in said organisms.

25. A method according to any one of claims 1-15, 17-24 wherein said position comprises a locus.

26. A method according to claim 25, wherein said locus is known to be a polymorphic locus.

27. A method according to claim 25 or claim 26, wherein the typing of DNA at said position comprises determining the allele(s) present at said position in said cells.

28. A method according to any one of claims 1-27, comprising determining the genotype of said at least two organisms at at least said first position.

29. A method according to any one of claims 1-28, comprising determining the genotype of said at least two organisms at at least a second position.

30. A method according to any one of claims 1-29, wherein said pooled sample is obtained by pooling cells of said at least two organisms.

31. A method of pooling samples to be analyzed for a categorical variable, wherein the analysis involves a quantitative measurement of an analyte, said method of pooling samples comprising providing a pool of n samples wherein the amount of individual samples in the pool is such that the analytes in the samples are present in a molar ratio of x⁰:xⁱ:x⁽ⁿ⁻¹⁾, and wherein x is the pooling factor, and is equal to a positive value other than 1 and n is the number of samples.

32. Method according to claim 31, wherein the analyte is a biomolecule and the categorical variable is a variant of said biomolecule.

33. Method according to claim 32, wherein the biomolecule is a nucleic acid.

34. Method according to claim 33, wherein the variant is a nucleotide polymorphism in said nucleic acid.

35. Method according to claim 34, wherein the nucleotide polymorphism is an SNP.

36. Method according to claim 35, wherein the variant is the base identity of a particular nucleotide position.

37. Method according to any one of the preceding claims, wherein the quantitative measurement comprises the measurement of the intensity, peak height or peak surface of an instrument signal.

38. Method according to claim 37, wherein the instrument signal is a fluorescence signal.

39. The use of a method according to any one of claims 1-38, for genotyping haploid or polyploid individuals for bi-allelic variants where the potential number of genotypes is p+1, wherein p represents the ploidy level.

40. Use according to claim 39, wherein x is 3, for genotyping an allelic variant in diploid individuals.

41. A method of performing an analysis on multiple samples, comprising pooling said samples according to a method of any one of claims 1-31 to provide a pooled sample and performing said analysis on said pooled sample.

42. A method of performing an analysis on multiple samples, comprising performing an analysis on a set of pooled sample obtained by a method according to any one of claims 1-38, wherein said sample is analyzed for a categorical variable and involves a quantitative measurement of an analyte in said sample.

43. Method according to claim 42, further comprising deducing from the measurement the contribution of the individual samples in said pool of samples.

44. A pooling device for pooling multiple samples into a pooled sample comprising a sample collector for providing a pooled sample and further comprising a processor for performing a method according to any one of claims 1-38.

45. An analysis device comprising a processor that is arranged for performing an analysis on a set of pooled sample obtained by a method according to any one of claims 1-38, wherein said device is arranged for analysing said sample for a categorical variable and for performing a quantitative measurement of an analyte in said sample.

46. Device according to claim 45, further including the pooling device of claim 44.

47. A computer program product either on its own or on a carrier, which program product, when loaded and executed in a computer, a programmed computer network or other programmable apparatus, puts into force a method of pooling samples according to any one of claims 1-38.

48. A computer program product either on its own or on a carrier, which program product, when loaded and executed in a computer, a programmed computer network or other programmable apparatus, puts into force a method for performing an analysis on multiple samples, said method comprising performing an analysis on a set of pooled sample obtained by a method according to any one of claims 1-47, wherein said sample is analyzed for a categorical variable and involves a quantitative measurement of an analyte in said sample.

49. Computer program product according to claim 48, wherein the method further comprises the step of pooling according to any of claims 1-38.

50. A method for determining a categorical variable in an analyte in at least two samples of an entity comprising said analyte in an assay, wherein the analysis involves a quantitative measurement of
said analyte,
said method comprising
obtaining from each of said at least two entities an individual sample comprising analyte of said entity
and
pooling said individual samples such that the ratio of the analytes of said at least two entities in the pool allows for the assay to discriminate between the frequencies of each potential value of said
categorical variable in said assay
said method further comprising
measuring the frequency of at least one of said potential values in said pooled sample and
determining from said measured frequency, the value of said categorical variable in said analyte of said at least two entities.
